(19) United States
(12) Patent Application Publication
(10) Pub. No.: US 2022/0327495 A1
(43) Pub. Date: Oct. 13, 2022

(54) INTELLIGENT SCHEDULING USING A PREDICTION MODEL

(71) Applicant: Kronologic, Inc., Austin, TX (US)

(72) Inventors: James Edward Allison, III, Austin, TX (US); Christopher Sean Anthony Lee, Austin, TX (US); Tomohiro Harayama, Lago Vista, TX (US)

(21) Appl. No.: 17/707,540

(22) Filed: Mar. 29, 2022

Related U.S. Application Data
(60) Provisional application No. 63/173,325, filed on Apr. 9, 2021.

(51) Int. Cl. G06Q 10/10; G06N 7/00; G06N 20/00

(52) U.S. Cl. CPC G06Q 10/1095; G06N 7/005; G06N 20/00

(57) ABSTRACT

Techniques described herein are directed to a scheduling platform configured to determine a time for scheduling a meeting. The scheduling platform receives a request for a new meeting and may associate the new meeting with available times on a calendar of a representative. The scheduling platform utilizes prediction model(s) to determine a probability of acceptance of an invitation to the meeting scheduled at each of the available times. Additionally, the scheduling platform may determine a joint probability of a multibook instance in which two or more invitations to meetings scheduled at a same time may be accepted. The scheduling platform selects the time for the new meeting based on the probability of acceptance and/or the joint probability of the multibook instance. The scheduling platform may deliver invitations that have a higher probability of acceptance in order to maximize a density of accepted meetings on a representative calendar.

### PRIORITY

This application claims priority to U.S. Provisional Patent Application No. 63/173,325, filed Apr. 9, 2021, and entitled “Intelligent Scheduling Using a Prediction Model,” the entire contents of which are incorporated herein by reference.

### BACKGROUND

Many work assignments involve meetings between a representative of an organization and another person, such as a client. Traditionally, meeting times are coordinated by the assigned representative and the other person, such as via electronic mail. For example, a representative may reserve a meeting time and provide the time to the other person to accept or decline the meeting invitation. However, this traditional system requires that the representative pick a random open time for the meeting, with little to no visibility into whether the other person is likely to accept the meeting. In some examples, the selection of an arbitrary time for the meeting and a lack of knowledge regarding acceptance rates associated therewith may result in meetings not getting scheduled, missed opportunities, and in some cases, lost revenue in business.

To address the aforementioned scheduling issues, some organizations may utilize a scheduling system configured to coordinate meeting times between the representative and another person. The scheduling system may identify a time for an appointment based on one or more available times on a calendar of the representative. The scheduling system may send an invitation for a meeting at an available time to the other person and may maintain the reserved time on the calendar of the representative until receiving an acceptance or until the reserved time has passed without a meeting. While the scheduling system improves upon traditional manual scheduling techniques, picking a meeting time based on representative availability and maintaining the reserved time on the calendar may result in poor utilization of the calendar time slots and may unduly tie up a representative's calendar.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example meeting scheduling optimization system usable to determine an optimal time for scheduling meeting instances, in accordance with examples of the disclosure.

FIG. 2 illustrates an example meeting acceptance probability model of a meeting scheduling optimization system usable to determine an optimal time for scheduling meeting instances, in accordance with examples of the disclosure.

FIG. 3 illustrates an example results page including data output by a scheduling optimization system, the data including acceptance probabilities and joint probabilities of a multibook instance associated with a meeting instance, in accordance with examples of the disclosure.

FIG. 4 illustrates another example results page including data output by a scheduling optimization system, in accordance with examples of the disclosure.

FIG. 5 illustrates an example multi-dimensional model of a scheduling optimization system usable to determine an optimal time for scheduling meetings, in accordance with examples of the disclosure.

FIG. 6 illustrates an example process for identifying an optimal time for scheduling a meeting based on probabilities of acceptance and probabilities of multi-book instances, in accordance with examples of the disclosure.

FIG. 7 illustrates an example process for identifying an optimal time for scheduling a meeting based on a probability of acceptance, a probability of a multibook instance and threshold values, in accordance with examples of the disclosure.

FIG. 8 illustrates an example process for updating an acceptance probability predictor for determining an acceptance probability of a meeting invitation based on characteristics associated therewith, in accordance with examples of the disclosure.

FIG. 9 is a block diagram illustrating an example system including a service computing device usable to implement example techniques described herein.

### DETAILED DESCRIPTION

Techniques described herein are directed to a scheduling platform configured to intelligently identify a time to schedule a meeting utilizing one or more prediction models. The scheduling platform may receive a request for a meeting and may input the meeting into one or more available time slots associated with a calendar of one or more representatives. The available time slot(s) may include times that are not associated with a confirmed meeting or are not otherwise blocked on the calendar. The prediction model(s) may determine a likelihood of acceptance (e.g., acceptance probability) of an invitation to the meeting associated with each time slot of the one or more available time slots. The prediction model(s) may determine the acceptance probability based on historical data associated with previously scheduled and/or attempted (e.g., not scheduled, declined invitation, etc.) meetings. In some examples, the scheduling platform may identify a particular time for the meeting based on the predicted acceptance probability. In some examples, the particular time for the meeting may be associated with the acceptance probability being equal to or greater than a threshold acceptance probability.

Additionally, the prediction model(s) may be configured to determine a probability of a multibook instance (e.g., joint probability of multibook instance, multibook probability) associated with each time slot of the one or more available time slots. The multibook instance may include an event in which two currently pending (e.g., open, not yet accepted or declined) meeting invitations are both accepted. In some examples, the scheduling platform may identify the particular time for the meeting based on the joint probability of multibook instance. The prediction model(s) may be configured to determine a joint probability of a multibook instance associated with each time slot of the one or more available time slots. In some examples, the particular time may be associated with the joint probability for a multibook instance being equal to or less than a prescribed threshold value.

In various examples, the scheduling platform may be configured to determine the particular time for the meeting based on representative and/or organizational preferences. The representative and/or organizational preferences may include, among other things, an indication of importance of the acceptance probabilities. For example, an organizational preference may include a preference to have meetings accepted regardless of the predicted acceptance probabilities. The scheduling platform may thus weight the acceptance probability higher than the joint probability of the multibook instance in the selection of the particular time for the meeting, such that the scheduling platform is configured to accept a higher threshold of joint probability of the multibook instance in order to ensure that a meeting invitation is accepted. For another example, a representative preference may include a preference to not have a multibook instance. The scheduling platform may thus set a threshold value for the joint probability of the multibook instance at an appropriate level to avoid the multibook instance.

In at least one example, the scheduling platform may send one or more invitations for the meeting, to be conducted at the particular time, to one or more contacts associated with the meeting. That is, the scheduling platform may be configured to identify the one or more contacts to be associated with the meeting and send the invitation(s) to the contact(s), such as via email, text message, social media message, and/or the like. In various examples, the scheduling platform can send the invitation(s) to the contacts in order of higher predicted acceptance probabilities prioritized over lower acceptance probabilities. In such examples, the scheduling platform may deliver invitations that have a higher probability of acceptance, in order for a calendar of a representative to be maximally densely populated with accepted meetings than, for example, a calendar that is populated using a conventional scheduling system (e.g., maximize a density of the calendar).

Techniques described herein improve current scheduling systems. Traditional scheduling systems select an available time, such as a first available time on a calendar of a representative assigned to conduct a meeting. However, this traditional system selects the time for the meeting regardless of consideration of whether it will be accepted and may reserve the time on the representative's calendar until the other person selects the particular time, which may take hours, days, or may not ever occur (e.g., no response to a meeting invitation). Because the time is selected in the traditional system based on availability and is then reserved on the calendar, the traditional scheduling system results in inefficiencies in scheduling and representative's calendar utilization or occupancy, as the representative may not schedule other meetings during the reserved time.

The techniques described herein provide an automated scheduling platform that may determine an optimal time for scheduling utilizing one or more meeting acceptance prediction models. Scheduling the optimal time can include an optimization problem that is framed from a point of view of each representative of an organization, maximizing the utilization or degree of occupancy of a calendar of the representative with as many scheduled meetings as possible during a period of time. The scheduling platform determines an acceptance probability and/or a joint probability of multibook instance associated with different meeting times and may schedule the meeting for a representative at a particular meeting time based on these probabilities. At least because the scheduling algorithm maximizes the function of predicted acceptance probabilities, the techniques described herein improve the efficiency in scheduling over traditional systems, by identifying a particular meeting time that is likely to be accepted. Further, because the scheduling platform sends invitations to one or more contacts in order of higher predicted acceptance probabilities prioritized over lower acceptance probabilities, a calendar of a representative may be more densely populated with accepted meetings than a calendar utilizing a conventional system. Moreover, the scheduling platform may identify a particular meeting time to ensure that a meeting associated therewith is not booked at the same time as another previously delivered open meeting invitation. Thus, techniques described herein improve an existing technological process of meeting scheduling.

Furthermore, traditional systems often require a significant number of messages to be sent between a scheduler (e.g., scheduling platform or representative) and the other party being invited to the meeting. For example, the other party may receive a first meeting invitation at a first time, but may decline the invitation due to unavailability. The scheduler may send an updated meeting request at a second time, which may, or may not be accepted. However, by selecting the particular time for the meeting based in part on an acceptance probability, the techniques described herein may decrease the number of updated meeting invitations from being sent back and forth to the other party. As such, the techniques described herein may reduce a total amount of network traffic associated with scheduling meetings by reducing a number of messages transmitted between the scheduler and the other party to determine a time for the meeting.

These and other aspects are described further below with reference to the accompanying drawings. The drawings are merely example implementations and should not be construed to limit the scope of the claims. For example, while examples are illustrated in the context of a scheduling meetings for a representative of an organization, the techniques described herein may also be applied to any other type of scheduling. For another example, though discussed primarily in the context of scheduling meetings between a representative and at least one contact, this is not intended to be so limiting, and the prediction models can additionally or alternatively be used to schedule assignments for tasks (e.g., meeting instances) for a representative and/or a contact. As discussed above, the task can include an action for the representative and/or the contact to perform and may associated with or independent of a meeting between the two parties.

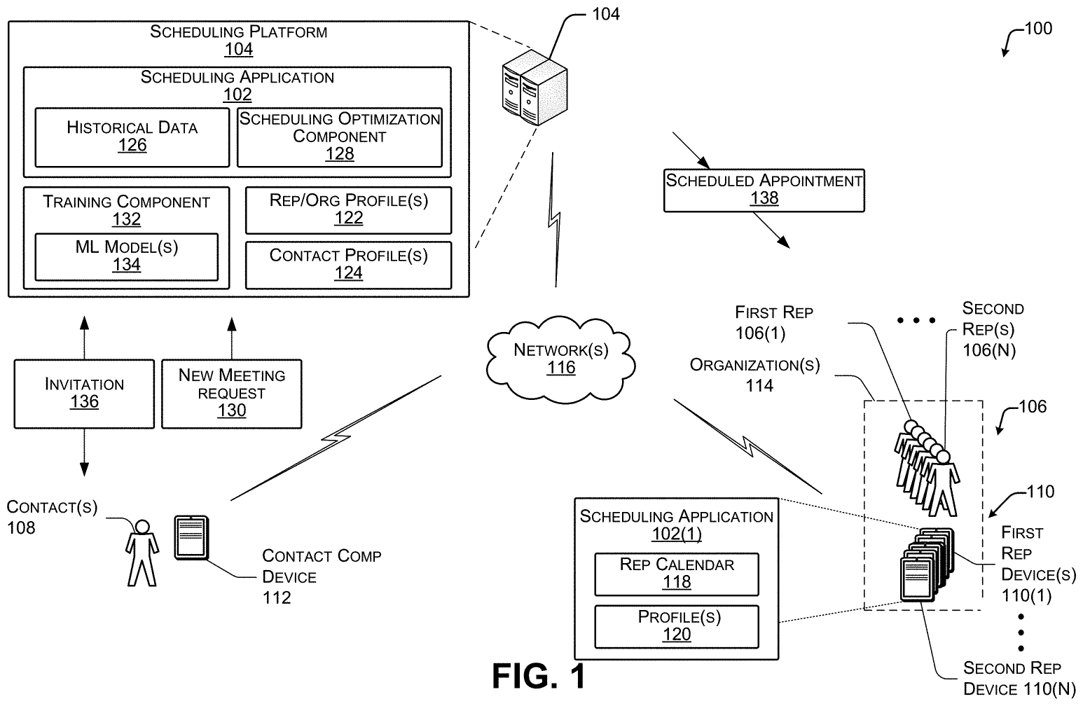

FIG. 1 is a schematic view of an example system 100 usable to implement the techniques described herein to determine an optimal time for scheduling appointments for meetings (e.g., task assignments, etc.) via a scheduling application 102. The system 100 may include a scheduling platform 104 configured to access and modify the scheduling application 102, such as to schedule appointments for meetings between one or more representatives 106(1) . . . 106(N) (collectively “representatives,” illustrated as reps for brevity) and one or more contacts 108(1) . . . 108(M) (collectively “contacts”). As discussed herein, a meeting can include a synchronous event scheduled at a particular time between a representative 106 and a contact 108. Additionally or alternatively, the scheduling platform 104 can be configured to schedule tasks or task assignments for a representative 106 and/or a contact 108. The task or the task assignment can be a synchronous or asynchronous event that may, or may not be associated with a scheduled meeting. For example, the scheduling platform 104 can be configured to assign a task to a representative 106, such as based on a request form a contact 108, the task including performing an action that is independent of a meeting between the representative and the contact 108. For another example, the scheduling platform can be configured to assign a task to a representative 106 and/or a contact 108 at the completion of a meeting between the representative 106 and the contact 108.

As illustrated, the representative(s) 106 may each have associated therewith a respective representative computing device 110(1) . . . 110(N) and the contact(s) may each have associated therewith one or more contact computing devices 112. In various examples, the representative(s) 106 may include employees, contractors, or the like of an organization 114. In such examples, one or more of the representative computing device(s) 110 may include a computing device associated with an organization 114.

Each of the representative computing devices 110 and the contact computing device(s) 112 include one or more processors and memory storing computer executable instructions to implement the functionality discussed herein attributable to the various computing devices. In some examples, the representative computing devices 110 and the contact computing device(s) 112 may include desktop computers, laptop computers, tablet computers, mobile devices (e.g., smart phones or other cellular or mobile phones, mobile gaming devices, portable media devices, etc.), or other suitable computing devices. The representative computing devices 110 and the contact computing device(s) 112 may execute one or more client applications, such as a web browser (e.g., Microsoft Windows Internet Explorer, Mozilla Firefox, Apple Safari, Google Chrome, Opera, etc.) or a native or special-purpose client application (e.g., scheduling applications, email applications, etc.), to access and view content over the network 116.

The network 116 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the representative computing devices 110 and/or the contact computing device(s) 112 may access the scheduling platform 104 and/or communicate with one another.

The scheduling platform 104 may include one or more servers or other computing devices, any or all of which may include one or more processors and memory storing computer executable instructions to implement the functionality discussed herein attributable to a scheduling platform. The scheduling platform 104 may access a first instance of a scheduling application 102(1) on a first representative computing device 110(1), to facilitate scheduling an assignment for a meeting between the associated representative 106 and the contact 108 and/or to facilitate scheduling a task assignment for the representative 106 to perform. In some examples, the first instance of the scheduling application 102(1) may include a user interface via which the associated representative 106 may view appointments on the calendar associated therewith. The calendar may include appointments automatically scheduled by the scheduling platform 104 and/or appointments scheduled by the representative 106.

In some examples, the scheduling platform 104 may manage the scheduling application 102. In such examples, the scheduling platform 104 may include the scheduling application 102. In some examples, the scheduling application 102 located on the scheduling platform 104 may include an application programming interface configured to communicate with the first instance of the scheduling application 102(1), such as to add create, modify and/or delete meetings on a calendar of a representative via the first instance of the scheduling application 102(1). Additionally, the application programming interface may be configured to receive data from a representative calendar 118 associated with the first instance of the scheduling application 102(1), such as to populate a secondary or master schedule comprising schedule and/or scheduling preference data associated with the representative 106(1).

In various examples, the representative computing device(s) 110 may store one or more profiles 120 associated with the representative and/or the organization. Similarly, the scheduling platform 104 may store one or more representative profiles and/or organization profiles 122. The representative profiles and/or organizational profiles 122 may include one or more preferences with regard to a scheduling optimization. In some examples, the preference(s) may include a first indication of a level of importance of a proposed meeting being accepted and/or a second indication of an accepted risk associated with a multibook instance. In some examples, the indication may include a desired threshold acceptance probability (e.g., meeting invitation 80% likely to be accepted, etc.) and/or a desired threshold joint probability of multibook instance (e.g., accept up to a 15% chance of a multibook instance). In some examples, the communication platform may be configured to determine the threshold probabilities based on the first indication and/or the second indication.

Representative profiles of the profile(s) 122 may include one or more characteristics associated with one or more representatives 106. The characteristics associated with a representative 106 may include a start time for a first meeting to be scheduled, an end time for a last meeting of the day to be started and/or finished (e.g., last meeting to start no later than 4 pm, last meeting to end no later than 4 pm, etc.), times for one or more breaks (e.g., lunch, coffee, smoke, etc.), maximum and/or minimum times to be scheduled for meetings (e.g., for each meeting based on meeting type, for all meeting, etc.), meeting scheduling preferences (e.g., maximum two meeting scheduled in a row for a representative, 15-minute break between scheduled meeting, maximum 5 meetings to be completed in a day, etc.), or the like. In some examples, the representative profiles of the profile(s) 122 may include historical performance data associated with a performance of the representative 106 at the organization and/or at other organizations. The historical performance data may include statistics associated with completing a meeting, converting a meeting to an opportunity (e.g., demonstration to a potential sale), converting an opportunity into a closed sale, average revenue per meeting performed, average profit per meeting performed, average cost per meeting performed, average value per meeting, and the like.

The organization profiles of the profile(s) 122 may include one or more characteristics associated with one or more organizations 114. The characteristic(s) associated with the organization may include one or more meeting settings associated with requested meetings to be automatically scheduled (e.g., requested meetings, periodic meetings, etc.), one or more meeting scheduling preferences (e.g., maximum two meetings scheduled in a row for a representative, 15-minute break between scheduled meetings, maximum 5 meetings to be completed in a day, etc.), scheduling model preferences (e.g., overall model preferences, model preferences based on meeting type, etc.), performance characteristics (e.g., performance based on meetings completed per hour, meetings completed per day, revenue per meeting, cost per meeting, value per meeting, etc.), and the like.

Additionally, in some examples, the scheduling platform 104 may include one or more contact profiles 124 associated with a contact. The contact may include a person outside the organization (e.g., not an employee or contractor thereof) associated with the meeting. In some examples, the contact may be a known entity (e.g., previous contact). In such examples, the scheduling platform may import contact data, such as from a contact profile 124 stored in a data store. The contact data may include one or more characteristics associated with the contact (e.g., name, address, electronic mail address, telephone number, social media handle, preferences, demographics (e.g., age, gender, education, employment, income, etc.), etc.), characteristic(s) associated with an organization of the contact (e.g., size of business, revenue, business type, etc.), previous meetings associated with the contact, representatives assigned to the previous meetings, revenue collected from the contact 108 and/or the organization associated therewith, a position of the contact at the organization associated therewith (e.g., Chief Executive Officer (CEO), Chief Financial Officer (CFO), President, manager, etc.) and the like. In examples in which the contact is not a known entity (e.g., new contact), the scheduling platform may configure data collection fields to collect data from the contact. In such examples, responsive to receiving the data from the contact, the scheduling platform may generate a contact profile 124 associated with the (new) contact.

In various examples, the scheduling platform may store historical data 126 associated with previously scheduled meetings and/or task assignments associated with representatives 106 and contacts 108. In the illustrative example, the historical data 126 is stored in association with the scheduling application 102, however this is not intended to be so limiting. In some examples, the historical data 126 may be stored on a datastore associated with the scheduling platform 104 that is accessible to the scheduling application 102 and/or a scheduling optimization component 128.

In some examples, the scheduling platform may store the historical data 126 in association with a particular organization 114 and/or with a plurality of organizations 114. In various examples, the historical data 126 may include meeting data associated with the previously scheduled meetings and/or assigned tasks. The meeting data may include known information about the previously scheduled meetings and/or task assignments, such as representative data (e.g., name, contact, preferences, productivity level, revenue, conversion rate, etc.), contact data, scheduling data (e.g., time of day, day of week, etc.), meeting data (e.g., meeting type, meeting value, revenue, cost, and/or value collected as a result of the meeting, etc.), invitation data (e.g., invitations delivered, updates requested from contact, invitations accepted, invitations ignored, invitations declined, etc.), and the like.

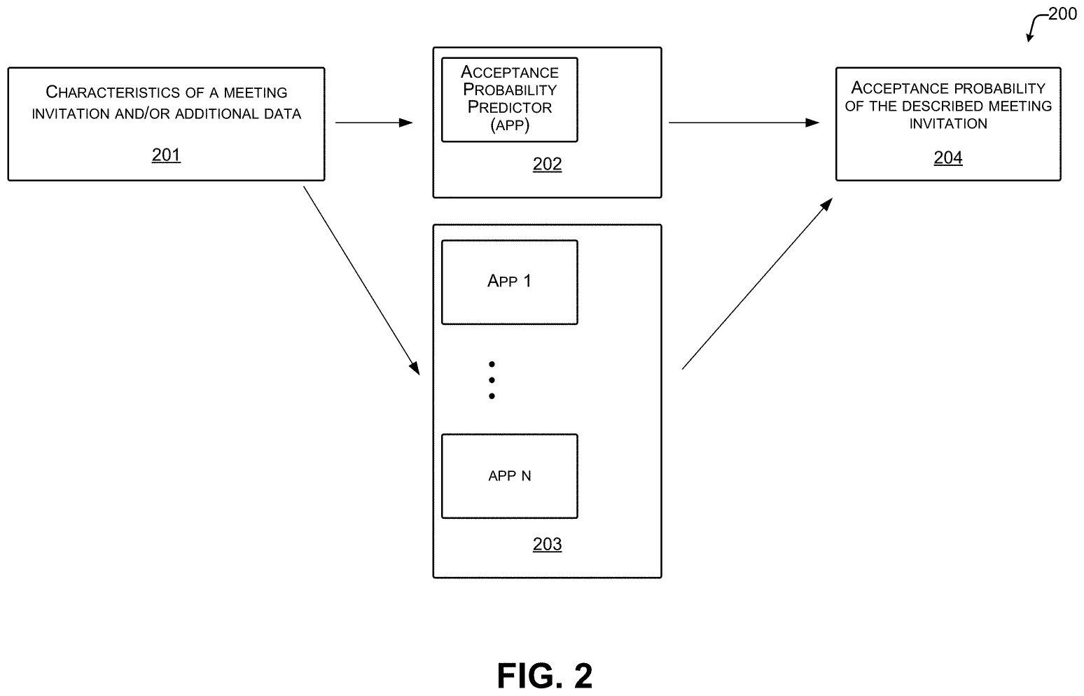

In various examples, the scheduling platform 104 may include a scheduling optimization component 128 configured to determine a time to schedule a meeting. The time for the meeting may be determined based on historical data 126 and optimized for a particular representative 106 and/or organization 114 thereof. In various examples, the scheduling optimization component 128 may include one or more prediction models configured to determine the time for the meeting based in part on a plurality of variables associated with the historical data 126. The variables may include information associated with the meeting data (e.g., characteristics of a meeting instance, representative data, contact data, scheduling data, meeting data, invitation data, etc.). In some examples, the prediction model(s) can include a spatial model. In some examples, and as described below with regard to FIG. 2, the prediction model(s) can include machine learning models configured to output an acceptance probability associated with a time on a calendar.

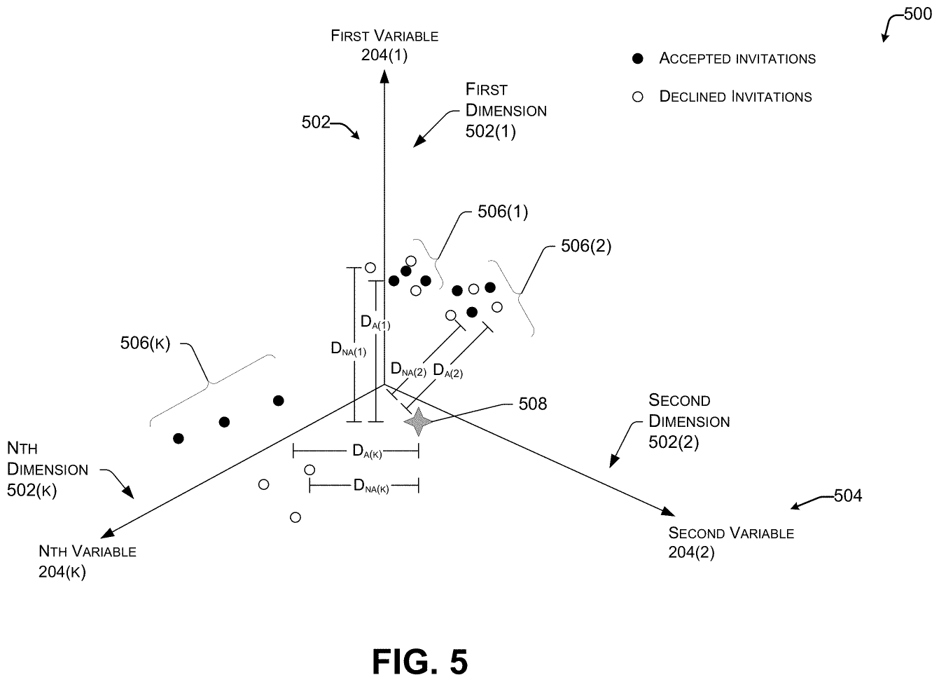

As will be discussed in further detail below with regard to FIG. 5, the prediction model(s) may include a multi-dimensional model configured based on the variables. In some examples, each dimension of the prediction model(s) may be associated with a particular variable. In some examples, the scheduling optimization component 128 may determine the variables to include in the prediction model(s). In some examples, the number of variables may include a pre-determined number of variables (e.g., 6, 15, 20, etc.). In some examples, the variables may include a set of variables that are determined by the scheduling optimization component 128 and/or the prediction model(s) to be relevant to the acceptance probability. In some examples, one or more of the set of variables may be selected at least in part by a particular organization 114 and/or a representative 106 thereof. In some examples, the organization 114 and/or the representative 106 may request that the prediction model(s) consider a particular variable. The prediction system may receive the request and may generate a new dimension associated with the particular variable. The prediction system may apply historical data 126 to the new dimension to determine whether the particular variable is relevant to the acceptance probability. As will be discussed below, the scheduling optimization component 128 and/or the prediction model(s) may additionally determine a weight associated with the particular variable based on the request.

The scheduling optimization component 128 may process the historical data 126 and may plot points associated with each dimension (e.g., axis associated with a variable) for accepted and declined invitations. In other words, the prediction model(s) may include a plurality of points corresponding to accepted and declined invitations plotted in each dimension based on a particular variable corresponding to the invitations. For example, a first dimension (e.g., first axis) of the prediction model(s) may be associated with a time of day of previous meeting invitations and a second dimension (e.g., second axis) of the prediction model(s) may be associated with a contact name associated with the contact. The prediction model(s) may include a first point representative of an accepted meeting plotted relative to the first dimension based on the time of day and a second point representative of the accepted meeting plotted relative to the second dimension based on the contact name.

In various examples, the scheduling optimization component 128 may be configured to determine whether a correlation exists between one or more variables and an acceptance of a meeting invitation based on the plotted points of historical data 126. In some examples, the correlation may be determined based on a cluster of points (e.g., accepted invitation points and declined invitation points) associated with one or more variables. The cluster of points may be associated with points that are within a threshold distance from a center of mass defined by the points. The threshold distance may be determined based on a number of variables considered (e.g., first threshold distance for one variables, second threshold distance for two variables, third threshold distance for three variables, and so on). For example, on an axis in which there is a correlation, the accepted invitation points and the declined invitation points cluster proximate one another. If another variable is added in which a correlation exists, another set of points will cluster with the other points within a threshold distance. If no correlation exists, the points will generate two cylinders of clusters, a first cylinder associated with accepted invitation points and a second cylinder associated with declined invitation points. As such, the additional set of points associated with the other variable will be plotted a distance from the cluster(s) of points associated with the initial variable(s).

In various examples, the scheduling optimization component 128 (and/or the prediction model(s) thereof) may be configured to assign a weight to each variable based at least in part on the plotted points. In some examples, the weight may be based on an average distance of the points from the center of mass. In various examples, the weight may represent a strength of the correlation between the variable an acceptance of a meeting invitation. In such examples, strong correlations between a variable and an acceptance of the meeting invitation may be weighted higher than other variables.

In various examples, the scheduling optimization component 128 may assign a first weight (e.g., 0.8, 1.5, etc.) to a first variable based on a first correlation value and a second weight (e.g., 0.2, 0.3, etc.) to a second variable based on a second correlation value, the second correlation value being different from the first correlation value. In some examples, the scheduling optimization component 128 may be configured to identify one or more variables in which the correlation value that is less than a threshold value (e.g., little to no correlation between the variable and acceptance of the meeting invitation). In such examples, the scheduling optimization component 128 may assign the variable(s) with a correlation value less than the threshold value a weight of zero (0), effectively treating the variables as noise. In such examples, the prediction model(s) may be configured to accurately determine an acceptance probability by weighting variables based on the correlation values.

As discussed above, the scheduling optimization component 128 may be configured to receive, from an organization 114 and/or a representative 106 thereof, a new variable to include in the prediction model(s). The scheduling optimization component 128 (prediction model(s) thereof) may generate the new dimension (e.g., new axis) associated with the new variable and apply the historical data to the new dimension to determine a correlation between the variable and an acceptance probability. In various examples, the prediction model(s) may automatically weight the new variable based on the determined correlation. In examples in which little to no correlation exists (e.g., correlation value below a threshold), the scheduling optimization component 128 may assign the new variable a weight of zero (0), such that the variable is associated with the model, but does not affect the outcome acceptance probability. In examples in which a correlation is determined, and based on the correlation value, the prediction model(s) utilize data associated with the new variable when determining an acceptance probability associated with a meeting invitation.

In various examples, the scheduling optimization component 128, utilizing the prediction model(s), may be configured to determine an acceptance probability of a meeting invitation based on variables and/or weights associated therewith. In various examples, the acceptance probability may be determined based on a similarity of a new meeting to meetings and/or invitations thereof corresponding to the historical data 126. In at least one example, the scheduling optimization component 128 may receive a request for a new meeting (e.g., new meeting request 130) and may determine characteristics associated with the request (e.g., contact data, meeting data, etc.). The scheduling optimization component 128 may associate the new meeting with one or more available times associated with one or more representatives. The available times may represent times that are not associated with a confirmed meeting or are not otherwise blocked on a calendar (e.g., a representative blocks a day as being unavailable, such as for vacation) associated with the one or more representatives.

In some examples, the available times may represent available times on a calendar of the representative between a maximum time period and/or minimum time period from a time associated with receiving the request. That is, the scheduling optimization component 128 can be configured to identify available times after a first threshold time associated with receiving the request and/or before a second threshold time associated with receiving the request. In some examples, the minimum time period may provide the contact and/or the representative with sufficient time to prepare for the meeting. For example, the minimum time period may include a period of 24 hours from receipt of the request, such that available times identified are no sooner than 24 hours from receipt of the request for a meeting instance. In some examples, the maximum time period may be configured to cause the meeting to be scheduled within a reasonable time period, such that, for example, the request for the meeting instance does not become moot or stale. For example, the maximum time period may include a period of one week (e.g., 7 days, 5 business days, 5 working days, etc.) from receipt of the request for the meeting instance.

In some examples, the maximum time period and/or the minimum time period may be determined by the scheduling platform 104. In such examples, the scheduling optimization component 128 may apply a same maximum time period and/or minimum time period to each scheduled meeting instance. In some examples, the maximum time period and/or the minimum time period may be included as a representative preference and/or organizational preference. In such examples, the maximum time period and/or the minimum time period can be stored in association with a representative and/or organizational profile 122. In some examples, the scheduling optimization component 128 may determine the maximum time period and/or the minimum time period based on data included in the request and/or contact data (e.g., data stored in a contact profile 124). For example, the request may include an indication that the associated contact would like the requested meeting scheduled within the next two weeks. As such, the scheduling optimization component 128 may determine that the maximum time period is two weeks from the received request. For another example, the scheduling optimization component 128 may receive the request from a contact 108 and may identify a user preference of the contact 108 that is associated with the minimum and/or maximum time periods, such as that stored in a contact profile 124.

In some examples, the scheduling optimization component 128 may be configured to determine one or more predicted future meetings. In such examples, the scheduling platform may be configured to hypothesize future meetings, such as to simulate time slot contention associated with one or more organizations. In various examples, the future meetings may be simulated based on heuristics associated with a particular organization and/or across organizations. The future meetings may be associated with a time of the year in which the meetings are hypothesized and/or other meeting data relevant to predicting a number or frequency of meetings. For example, the scheduling platform may predict future meetings at the beginning of a fiscal year, when budgets are renewed. In various examples, the available times may represent times that are not associated with one or more predicted future meetings.

In various examples, the prediction model(s) of the scheduling optimization component 128 may plot a point associated with the new meeting based on the corresponding variables and at a time of the one or more available times. The prediction model(s) may determine a first distance from the point to each of the accept invitation points and a second distance from the point to the decline invitation points. In some examples, the prediction model(s) may determine a first average (e.g., mean, median, mode, etc.) distance associated with the accept invitation points and a second average distance associated with the decline invitation points. In various examples, the prediction model(s) may determine the acceptance probability based on the first and second average distances. In at least one example, the acceptance probability may be determined based on weighted first and second average distances, utilizing the calculated variable weights, as described above.

A formulaic representation of the acceptance probability determination may be represented in the following equations (1)-(5). Given a training dataset of n historic proposals (e.g., rows), each with k input attributes (e.g., columns) and an output terminal state

$$H = [ \begin{matrix}{h}_{1 , 1} & {h}_{1 , 2} & … & {h}_{1 , k} \\ {h}_{2 , 1} & {h}_{2 , 2} & … & {h}_{2 , k} \\ ⋮ & ⋮ & ⋱ & ⋮ \\ {h}_{n , 1} & {h}_{n , 2} & … & {h}_{n , k}\end{matrix} \vert \begin{matrix}{v}_{1} \\ {v}_{2} \\ ⋮ \\ {v}_{n}\end{matrix} ] \qquad ( 1 )$$

where hᵢⱼ represents a proposal i and attribute j and vᵢ is 0 if the meeting invitation is rejected, 1 if the meeting invitation is accepted, and ignored if not terminated (e.g., neither accepted nor rejected).

The scheduling optimization component 128 may determine the standard deviation of each input column j and its correlation with an output state v as represented by the following equations:

$$\begin{matrix}[ {σ}_{1} & {σ}_{2} & … & {σ}_{k} ] , {σ}_{j} = σ ( \begin{matrix}{h}_{1 , j} \\ {h}_{2 , j} \\ ⋮ \\ {h}_{n , j}\end{matrix} )\end{matrix} \qquad ( 2 )$$

$$\begin{matrix}[ {ρ}_{1} & {ρ}_{2} & … & {ρ}_{k} ] , {ρ}_{j} = ρ ( \begin{matrix}{h}_{1 , j} \\ {h}_{2 , j} \\ ⋮ \\ {h}_{n , j}\end{matrix} \vert \begin{matrix}{v}_{1} \\ {v}_{2} \\ ⋮ \\ {v}_{n}\end{matrix} )\end{matrix} \qquad ( 3 )$$

In various examples, given a new candidate proposal slot with the following input attributes:

C=[c₁ c₂ . . . cₖ] (4)

The acceptance probability α is the average of its weighted distance (squared L2-norm) to the known terminal states νᵢ associated with the historic proposals. Each dimension (e.g., variable) j is z-score normalized (to σⱼ) and weighted by its historic correlation with accept rate (ρⱼ):

$$a = {\sum }_{i = 1}^{n} {w}_{i} {v}_{i} , {w}_{i} = \frac{1}{{\sum }_{j = 1}^{k} {( \frac{{ρ}_{j} ( {h}_{j} - {c}_{j} )}{{σ}_{j}} )}^{2}} \qquad ( 5 )$$

In various examples, the scheduling optimization component 128 may determine a particular time to associate with the new meeting corresponding to the request based on a determined time a highest acceptance probability. In various examples, the scheduling optimization component 128 may determine the particular time to associated with the new meeting based on a determination that an acceptance probability associated with the particular time is above a threshold probability. In some examples, the threshold probability may be determined based on one or more organizational and/or representative preferences, such as those stored in the organization and/or representative profile(s) 122.

In some examples, the scheduling optimization component 128 may additionally or alternatively utilize one or more classical regression models configured to fit curves to each column in H and interpolate C along those curves. In some examples, the prediction model(s) described above may utilize historical data 126 associated with multiple organizations (e.g., the organization associated with the new meeting request and/or other organizations). In some examples, the organizations may include different types of organizations. In such examples, the scheduling optimization component 128 may select at least a portion of the historical data 126 associated with a plurality of organizations for determining correlations, weights, acceptance probabilities, and the like.

In some examples, the other organizations may include organizations that are similar to the organization associated with the new meeting request (e.g., same or similar organization or business type, similar location, similar size, similar customer base, etc.). In some examples, the scheduling optimization component 128 may be configured to determine similar organizations utilizing machine learning techniques. In such examples, a training component 132 of the scheduling platform 104 may include one or more machine learning models 134 (illustrated as ML model 134) trained to identify one or more other organizations similar to an organization corresponding to a new meeting request. In various examples, the similar organizations may be stored in association with the scheduling platform 104, such as in the representative and/or organizational profile(s) 122.

In various examples, the prediction model(s) described above may utilize historical data 126 associated with a single organization (e.g., organization associated with the new meeting request) to determine the correlations, weights, and/or acceptance probabilities. In examples in which the single organization is a new organization, and thus does not have a sufficient historical data corpus to accurately determine acceptance probabilities, the scheduling optimization component 128 may include an a priori regression model and/or a proximity test based on a canon of historical data 126 gathered from other organizations, such as the similar or different organizations described above. In some examples, the canon of historical data 126 from the other organizations may be selected such that it blends out to zero weight as the historical data 126 associated with the new organization grows.

In various examples, the training component 132 of the scheduling platform may be configured to update the prediction model(s) periodically (e.g., weekly, monthly, etc.). In some examples, the prediction model(s) may be updated continuously, such as with a delivery and/or received response associated with a new meeting invitation. In various examples, the prediction model(s) may be updated responsive to receiving a request, such as from a user, to update the model based on additionally gathered historical data 126 since a last update. In various examples, a training of the training component 132 may be configured to maintain a k-dimensional tree in O (klogn) per proposal, which may reduce a computational time from O(nk) to amortized O(klog₂n) by filtering out points in H too distance from C to materially affect acceptance probability.

In various examples, the training component 132 may additionally be configured to train one or more machine learning models 134 to determine an acceptance probability based on the historical data 126 (e.g., training data). Given an input of a new meeting request 130 and a given time associated therewith, the machine learning model(s) 134 may be trained to output an acceptance probability. The scheduling optimization component 128 may select a particular time to assign to a meeting associated with a new meeting request 130 based at least in part on the acceptance probability associated with the particular time (e.g., highest time, at or above a threshold probability, based on preferences, etc.). In various examples, the scheduling optimization component 128 may send, to a contact computing device 112 associated with the contact 108, an invitation 136 for the new meeting at the particular time. In some examples, the scheduling optimization component 128 may additionally send a tentatively scheduled meeting 138 to a representative computing device 110 corresponding to the representative 106 associated with the meeting.

Additionally or in the alternative, the scheduling optimization component 128 may determine the particular time to associated with the new meeting based on a determined joint probability of multibook instance. In some examples, the scheduling optimization component 128 may be configured to determine a probability that the particular time will be double, triple booked, or the like, with other meetings associated with pending meeting invitations (e.g., other meeting invitations that have previously been delivered to contacts). In time slots in which there are no meetings associated therewith, the scheduling optimization component 128 determines the joint probability of multibook instance of zero (0). In various examples, the scheduling optimization component 128 may identify times (e.g., time slots) that have two or more pending (e.g., not accepted or declined) meeting invitations associated therewith and may determine a probability that at least two of the pending meeting invitations will be accepted.

In various examples, the scheduling optimization component 128 determines the joint probability of multibook instance by inputting the data associated with the time slot into a model configured to remove the weights determined by the prediction model(s) and determine a probability that at least one of the pending and the new meeting invitation will be accepted. In various examples, the scheduling optimization component 128 may be configured to optimize between the acceptance probability and the joint probability of multibook instance to identify an optimal time for scheduling a new meeting.

In some examples, the scheduling optimization component 128 may determine a first set of times that satisfy one or more first criteria associated with the acceptance probability (e.g., highest acceptance probability, above a threshold, satisfies preferences, etc.). The scheduling optimization component 128 may evaluate a joint probability of multibook instance associated with each time of the first set of times. In some examples, the scheduling optimization component 128 may select the particular time based on a time that satisfies one or more second criteria with respect to the joint probability of multibook instance. The second criteria may include a lowest joint probability of multibook instance, a threshold joint probability of multibook instance, a preference to weight joint probability of multibook instance over acceptance probabilities or vice versa (e.g., determining weighted probabilities and comparing the weighted values), and/or the like. For example, the scheduling optimization component 128 may identify a first weight to apply to acceptance probabilities and a second weight to apply to joint probabilities for multibook instances. The scheduling optimization component 128 may thus determine the respective probabilities and apply the first weight and the second weight to the relevant probabilities to determine weighted acceptance probabilities and weighted probabilities of multibook instances. The scheduling optimization component 128 may determine the time based on the weighted probabilities, such as to maximize an acceptance rate while also maximizing a density of a calendar of the representative. In at least one example, the scheduling optimization component 128 may identify the particular time based on a determination that the particular time has an acceptance probability above a first threshold (e.g., 80%, 87%, 92%, etc.) and a joint probability of multibook instance below a second threshold (e.g., 8%, 10%, 13%, etc.).

In various examples, an organization 114 and/or representative 106 may determine the threshold criteria for one or more of the acceptance probability or the j oint probability of multibook instance. For example, the organization 114 may indicate a preference to have meetings accepted, regardless of a risk of a multibook instance. In such an example, the acceptance probability threshold may be set to ensure that an optimal time for meeting acceptance is selected. The joint probability of multibook instance threshold may not be set or may be elevated based on the risk tolerance for the multibook instance. For example, a first organization may set a first preference to maximize acceptance of meeting invitations (e.g., 90% and above acceptance probability of a meeting, etc.) and accept a relatively high level of risk of a multibook instance (e.g., 15%, 20% joint probability of multibook instance, etc.). A second organization may set a second preference to minimize the risk of a multibook instance (e.g., less than 5%, 7%, 10% joint probability of multibook instance, etc.) and risk a lower acceptance probability (e.g., 75%, 80%, etc. and above acceptance probability of a meeting). Though these are merely examples, and additional or alternative probabilities, and/or other conditions may be input as preferences.

In various examples, the scheduling optimization component 128 may include default thresholds associated with the acceptance probability and/or the joint probability of multibook instance. In some examples, the default thresholds may be set select an optimal time for scheduling a meeting, while balancing the acceptance probability and/or joint probability of multibook instance.

In various examples, responsive to selecting the particular time that satisfies the acceptance probability and/or the joint probability of multibook instance, such as based on preferences associated with a particular organization 114 and/or representative thereof, the scheduling optimization component 128 may send, to the contact computing device 112 associated with the contact 108, the invitation 136 for the new meeting at the particular time. In some examples, the scheduling optimization component 128 may additionally send a tentatively scheduled meeting 138 to a representative computing device 110 corresponding to the representative 106 associated with the meeting.

FIG. 2 illustrates a schematic example of a prediction system 200 configured to predict an acceptance probability of a meeting invitation. In at least one example, the prediction system 200 may be included in a training component, such as training component 132, that is configured to output a probability that a meeting invitation will be accepted, such as based on characteristics associated with the meeting invitation and/or the meeting instance. As used herein, characteristics associated with the meeting invitation and/or the meeting instance may include variables associated with the meeting invitation and/or the meeting instance. That is, characteristics and variables may be used interchangeably throughout this disclosure.

In the illustrative example, the prediction system 200 includes a first prediction component 202 and a second prediction component 203 configured to assist in determining the acceptance probability of a meeting invitation. However, this is merely for illustrative purposes, and it is understood that the prediction system 200 may include either a single acceptance probability predictor (e.g., the first prediction component 202) or an ensemble prediction component (e.g., second prediction component 203) including two or more predictors (e.g., two or more APPs). For example, a first prediction system 200 may include the first prediction component 202 and a second prediction system 200 may include the second prediction component 203.

In at least one example, the first prediction component 202 and/or the second prediction component 203 may receive input 201. The input 201 may include characteristics (e.g., variables) of a meeting invitation, such as that generated by a representative of an organization and/or the scheduling platform. Non-limiting examples of the characteristics may include a meeting type (e.g., demonstration, periodic check-in, lunch, happy hour, etc.), a scheduling distribution model associated with scheduling the meeting instance (e.g., random scheduling, sequential scheduling, high density scheduling, etc.), one or more representative identifiers associated with one or more hosts or presenters, a time associated with the meeting instance (e.g., date, time, etc.), a time associated with the invitation (e.g., period of time before the meeting instance is scheduled, time associated with a scheduled delivery of the invitation, etc.), a meeting length, whether the meeting instance is a recurring meeting or single instance, one or more contact identifiers to be associated with the meeting instance, an indication of a single guest (e.g., a single contact) or multi-guest (e.g., one or more contacts) associated with the meeting instance, and one or more contact designations (e.g., primary contact, secondary contact, mandatory attendance, optional attendance, etc.).

In some examples, the input 201 may additionally include additional data associated with one or more parties of the meeting invitation. In at least one example, the additional data can include representative characteristics and/or contact characteristics. Representative characteristics can include representative scheduling data (e.g., start time, end time, break time(s), etc.), representative preferences (e.g., maximum and/or minimum times for scheduling meetings, etc.), demographic information (e.g., age, gender, etc.), location data (e.g., physical location, work location, etc.), preferred language, historical performance data, and/or the like. Contact characteristics may include a name, employment data (e.g., job title, position, associated organization), contact information (e.g., email address, phone number, social media handle(s), etc.), location data (e.g., physical location, etc.), demographic data (e.g., age, gender, etc.), historical meeting data (e.g., previous sales, previous meeting data between the contact and a representative of an organization, etc.), revenue collected from the contact and/or organization associated therewith, potential meeting values, and/or the like.

In various examples, the first prediction component 202 and/or the second prediction component 203 may be configured to receive the input 201 and output an acceptance probability 204 associated with the meeting invitation. That is, the first prediction component 202 and/or the second prediction component 203 may receive the input 201 and based on the characteristics of the meeting invitation and/or additional data, the first prediction component 202 and/or the second prediction component 203 may provide the probability that the particular meeting invitation will be accepted (e.g., acceptance probability 204). In various examples, the first prediction component 202 and/or the second prediction component 203 may include machine learning models configured to receive the input 201 and output and the acceptance probability 204.

In some examples, the first prediction component 202 and/or the second prediction component 203 may include a time-independent predictor, such as XGBoost or other neural network configured utilizing a supervised learning method. In such examples, the first prediction component 202 and/or the second prediction component 203 may be configured to receive variables associated with a meeting invitation (e.g., characteristics) that operate as abstract variables that are independent of a time (e.g., traditional clock time, etc.).

In some examples, the first prediction component 202 and/or the second prediction component 203 may include a time series forecaster, such as AR MA or other neural network that is time dependent. In such examples, the first prediction component 202 and/or the second prediction component 203 may be trained utilizing a supervised learning method with variables that are dependent on the time associated with the input 201 (e.g., dependent on times associated with various characteristics included in the input 201). In some examples, the first prediction component 202 and/or the second prediction component 203 may include a machine learning model that is configured utilizing an unsupervised learning method.

Additionally or alternatively, the first prediction component 202 and/or the second prediction component 203 may include a machine-human hybrid model, random oracle, expert, and/or another non-machine learning predictor. That is, the first prediction component 202 and/or the second prediction component 203 may include any type of component(s) that can be configured to receive an input 201 and provide an output, such as the acceptance probability 204.

In at least one example, a machine learning model of the first prediction component 202 and/or the second prediction component 203 may be trained utilizing historical data associated with meeting scheduling, such as historical data 126. In such an example, the first prediction component 202 and/or the second prediction component 203 may be configured to process the historical data to derive historical acceptance probabilities for various subsets of the historical data. In some examples, the historical acceptance probabilities may be used as ground truth of the supervised learning method, such as to derive training datasets. In some examples, the training data can include data obtained from one or more other sources (e.g., outside of an organization), such as that obtained for an industry, market, economy, and/or other broader sources.

In some examples, the second prediction component 203 may be configured to aggregate acceptance probabilities determined by two or more acceptance probability predictors. In such examples, the second prediction component 203 may be configured to combine acceptance probabilities into a single result (e.g., a scalar value, a vector, and/or a tensor, etc.) that may be output as an acceptance probability 204. In various examples, the second prediction component 203 may be configured to aggregate the acceptance probabilities by averaging the different acceptance probabilities determined by the acceptance probability predictors. In some examples, the second prediction component 203 may utilize a weighted averaging method to determine the average acceptance probability. In such examples, the second prediction component 203 may apply a normalized weight vector to the output vector to calculate the average acceptance probability. In various examples, the average acceptance probability can be provided as the acceptance probability 204 (e.g., prediction model(s) output).

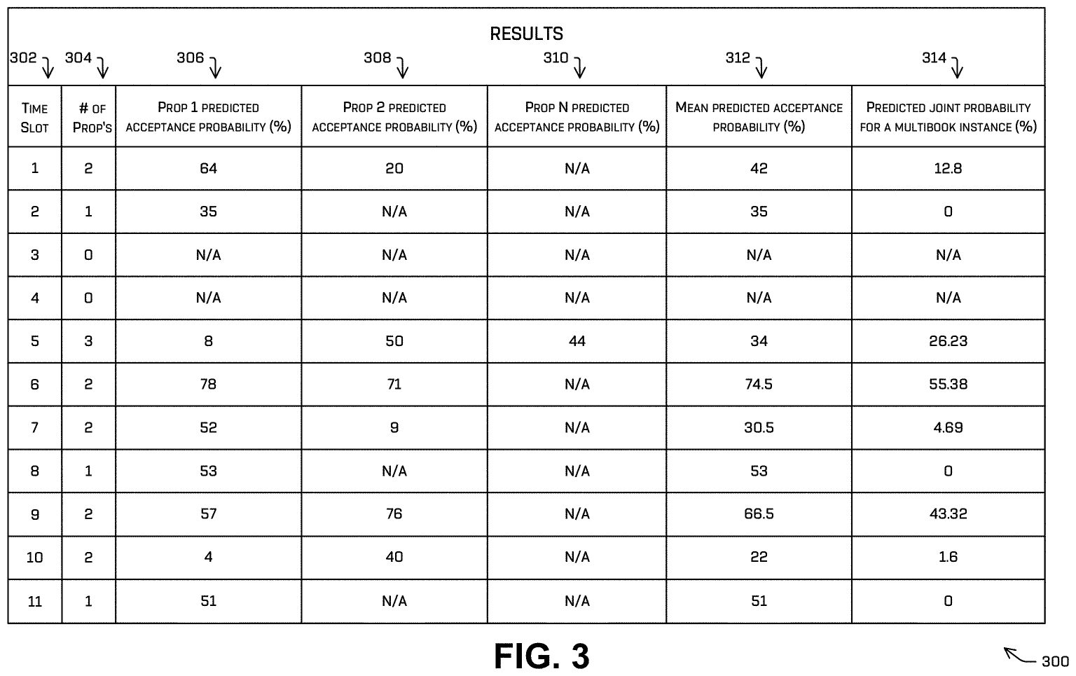

FIG. 3 illustrates an example results page 300 of acceptance probabilities and joint probabilities of a multibook instance associated with a meeting instance, as determined by a scheduling optimization system. In at least one example, a prediction model, such as prediction model 200, prediction model 500, and/or the like, of the scheduling optimization system (e.g., a scheduling platform) may be configured to output the data included in the results page 400 (e.g., acceptance probability 204).

In the illustrative example, the results page 300 includes data associated with 11 time slots 302, though this is merely for an illustrative example, and the scheduling platform may consider a greater or lesser number of time slots 302. In various examples, the time slots 302 may represent available times on a calendar associated with one or more representatives. In some examples, the one or more representatives may be determined based on a new meeting request received from a contact. In such examples, the contact may specify a particular representative to associate with a meeting. For example, a meeting request may include a request to schedule a meeting with Representative A. In such examples, the time slots 302 may include available times on Representative A′s calendar. In some examples, the one or more representatives may be determined utilizing techniques such as those described in U.S. patent application Ser. No. 16/880,977, filed May 21, 2020 and entitled “Intelligent Scheduling,” the entire contents of which are incorporated herein by reference for all purposes.

In various examples, the scheduling platform may be configured to determine one or more pending meeting invitations (e.g., meeting invitations sent but not yet accepted or declined) associated with each time slot. In some examples, the results page 300 may include a number of proposals column 304 indicating the number of proposals that are associated with each time slot 302. That is, the number of proposals may include a number of potential meeting instances that may be associated with that time slot. As illustrated in FIG. 3, the number of proposals column 304 may include any number of potential meeting instances that may be associated with a respective time slot, from 0 to N, N being a positive, non-zero integer.

In some examples, the results page 300 may include an indication of an acceptance probability (e.g., acceptance probability 204) associated with each of the pending invitations. For example, a first acceptance probability column 306 may include an indication of an acceptance probability associated with a first pending meeting invitation associated with a respective time slot 302, a second acceptance probability column 308 may include an indication of an acceptance probability associated with a second pending meeting invitation associated with the respective time slot 302, and an Nth acceptance probability column 310 may include an indication of an acceptance probability associated with an Nth pending meeting invitation associated with the respective time slot 302. That is, the scheduling platform (e.g., scheduling optimization system) can be configured to identify any number from 1−N, where N is a positive integer greater than 1, of predicted acceptance probabilities of potential meeting instances associated with a particular time slot 302.

As an illustrative example, the first time slot includes a first probability of 64% that a first pending meeting invitation will be accepted, and a second probability of 20% that a second pending meeting invitation will be accepted. At least because the number of proposals column 304 indicates that two proposals are associated with the first time slot, the scheduling platform does not calculate additional probabilities associated with other pending meeting invitations (e.g. indicating a “N/A” result in the Nth acceptance probability column 310).

In various examples, the results page 300 may include predicted mean acceptance probability column 312 indicative of a total probability that the respective time slot 302 will have an accepted meeting. Continuing the example of the first time slot from above, the predicted mean acceptance probability column 312 includes an indication that a total probability that the first time slot 302 will be eventually booked is 42%. In at least one example, the predicted mean acceptance probability column 312 may include values associated with the simple arithmetic mean of the number of predicted acceptance probabilities, such as those determined in association with the first acceptance probability column 306, the second acceptance probability column 308, and the Nth acceptance probability column 310.

In some examples, the value associated with a time slot in the predicted mean acceptance probability column 312 may represent a probability that a single meeting instance associated with the time slot will be accepted. In some examples, the results page 300 may include a probability that two or more meeting invitations associated with a time slot (e.g., two or more proposals) will be accepted (e.g., joint probability of a multibook instance), such as in a joint probability of multibook instance column 314 associated with the respective time slot 302 based on the pending meeting invitations (e.g., pending proposals). In at least one example, the scheduling platform can determine the joint probabilities of the multibook instance included in the column 314 by subtracting the sum of acceptance probabilities associated with the proposals from 1 or 100. In some examples, the j oint probabilities that two or more meeting invitations associated with a time slot will be accepted, such as that included in column 314, may be determined by subtracting the sum of the probabilities of zero or one meeting invitation being accepted from 1 or 100. For example, a joint probability of a multibook instance associated with the first time slot may be determined by 1 minus the probability that none of the two meetings are accepted (e.g., 0.36×0.80=0.288) minus the probability that only one of the two meetings are accepted (e.g., 0.64×0.80+0.36×0.2=0.584). Thus, the joint probability associated with the first time slot may be defined by 1−0.288−0.584=0.128. In examples in which three or more proposals are pending, the joint probability of a multi book instance, in which at least two of the three or more proposals are accepted, can be represented by 1 minus probability that none of two of the meetings will be accepted minus the probability that only one of the two meetings is accepted.

In various examples, the scheduling platform can utilize the acceptance probabilities, such as those illustrated in acceptance probability columns 306, 308, and 310 and/or predicted mean acceptance probability column 312, and/or the joint probability for a multibook instance, such as that illustrated in joint probability of multibook instance column 314, to identify a time to associate with a meeting instance. In at least one example, the scheduling platform will determine an optimized time for the meeting instance, such as to maximize a probability that a meeting will be accepted during the time slot, such as to ensure that a calendar of a representative is densely populated.

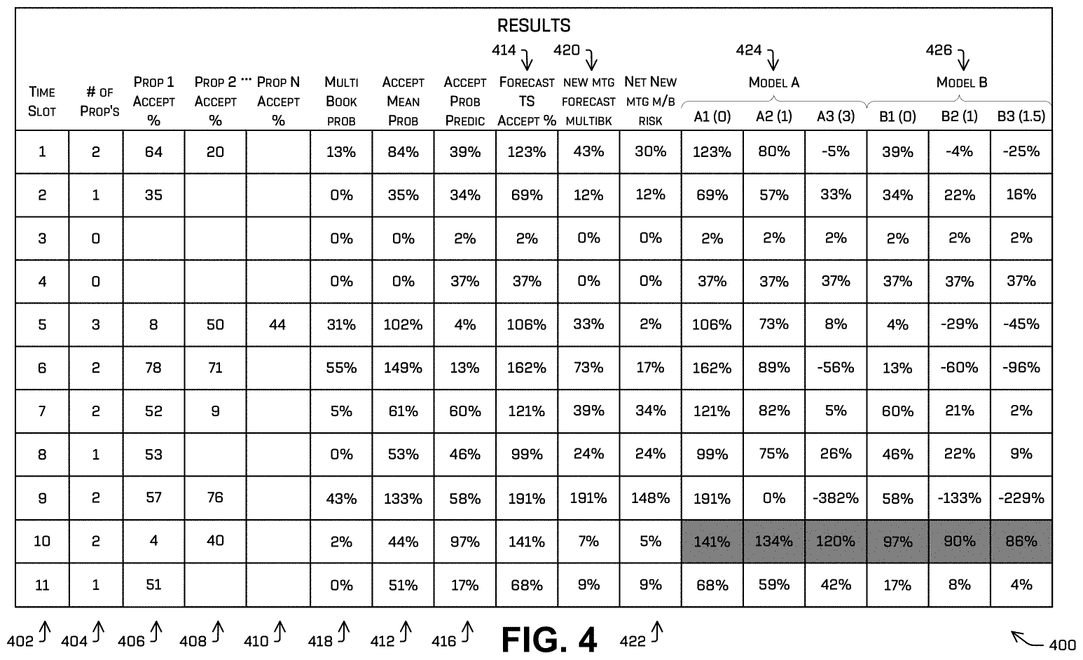

FIG. 4 illustrates a results page 400 of probabilities output by a scheduling optimization system, in accordance with examples of the disclosure. In at least one example, a prediction model, such as prediction model 200, prediction model 500, and/or the like, of the scheduling optimization system (e.g., a scheduling platform) may be configured to output the data included in the results page 400.

In the illustrative example, the results page 400 includes data associated with 11 time slots 402, though this is merely for an illustrative example, and the scheduling platform may consider a greater or lesser number of time slots 402. In various examples, the time slots 402 may represent available times on a calendar associated with one or more representatives. In some examples, the one or more representatives may be determined based on a new meeting request received from a contact. In such examples, the contact may specify a particular representative to associate with a meeting. For example, a meeting request may include a request to schedule a meeting with Bob. In such examples, the time slots 402 may include available times on Bob's calendar. In some examples, the one or more representatives may be determined utilizing techniques such as those described in U.S. patent application Ser. No. 16/880,977, the entire contents of which are incorporated herein by reference above.

In various examples, the scheduling platform may be configured to determine one or more pending meeting invitations (e.g., meeting invitations sent but not yet accepted or declined) associated with each time slot. In some examples, the results page 400 may include a number of proposals column 404 indicating the number of proposals in each time slot 402. In some examples, the results page 400 may include an indication of an acceptance probability associated with each of the pending invitations. For example, a first acceptance probability column 406 may include an indication of an acceptance probability associated with a first pending meeting invitation associated with a respective time slot 402, a second acceptance probability column 408 may include an indication of an acceptance probability associated with a second pending meeting invitation associated with the respective time slot 402, and a third acceptance probability column 410 may include an indication of an acceptance probability associated with a third pending meeting invitation associated with the respective time slot 402. As an illustrative example, the fifth time slot includes a first probability of 8% that a first pending meeting invitation will be accepted, a second probability of 50% that a second pending meeting invitation will be accepted, and a third probability of 44% that a third pending meeting invitation will be accepted.

In various examples, the results page 400 may include predicted mean acceptance probability column 412 indicative of a total probability that the respective time slot 402 will have an accepted meeting. Continuing the example of the fifth time slot from above, the predicted mean acceptance probability column 412 includes an indication that a total probability that the fifth time slot 402 will be eventually booked is 34%. In some examples, the data may include a forecast time slot accept percentage column 414 with percentages calculated based on the accept mean probabilities associated with column 412 and the acceptance probability predictions associated with column 416. The forecast time slot accept percentage column 414 may include a probability that a particular time slot will have an accepted invitation. In various examples, the scheduling platform may be configured to optimize this value to ensure a calendar is scheduled to maximum utilization (e.g., capacity).

In at least some examples, the acceptance probabilities may be determined utilizing one or more of the following equations. Given n meeting proposals competing for a timeslot, with the following independent acceptance probabilities and corresponding rejection probabilities:

P=[ρ₁ ρ₂ . . . ρₙ] (6)

R=[r₁ r₂ . . . rₙ]=[1−ρ₁ 1−ρ₂ . . . pₙ] (7)

The probability of all n proposals being accepted and rejected are, respectively:

αₙ=ΠP=ρ₁ρ₂ . . . pₙ (8)

αₙ=ΠR=τ₁τ₂ . . . τₙ (9)

In various examples, the dot product of unordered m-subsets from P and corresponding complementary subsets from R may be used to determine the probability of m accepted proposals among n total proposals. In such examples, a naïve cost may be represented as O(n!/m!) which may be reduced to O(nm) by reusing partial sums.

In various examples, the general form may appear like a triangle/pyramid in m dimensions, as represented by equation (10) as follows:

$${a}_{m} = {a}_{0} {\sum }_{i = 1}^{n - m + 1} {p}_{i} / {r}_{i} {\sum }_{j = i + 1}^{n - m + 2} {p}_{j} / {r}_{j} {\sum }_{k = j + 1}^{n - m + 3} {p}_{k} / {r}_{k} …$$

For two accepted proposals (i.e., m=2), the probability may be represented as follows:

$${a}_{2} = {a}_{0} [ \begin{matrix}{p}_{1} {p}_{2} & {p}_{1} {p}_{3} & … & {p}_{1} {p}_{n} \\ & {p}_{2} {p}_{3} & … & {p}_{2} {p}_{n} \\ & & ⋱ & ⋮ \\ & & & {p}_{n - 1} {p}_{n}\end{matrix} ] \cdot [ \begin{matrix}1 / ( {r}_{1} {r}_{2} ) & 1 / ( {r}_{1} {r}_{3} ) & … & 1 / ( {r}_{1} {r}_{n} ) \\ & 1 / ( {r}_{2} {r}_{3} ) & … & 1 / ( {r}_{2} {r}_{n} ) \\ & & ⋱ & ⋮ \\ & & & 1 / ( {r}_{n - 1} {r}_{n} )\end{matrix} ] \qquad ( 11 )$$

$$= {a}_{0} {\sum }_{i = 1}^{n - 1} \frac{{p}_{i}}{{r}_{i}} {\sum }_{j = i + 1}^{n} \frac{{p}_{j}}{{r}_{j}} \qquad ( 12 )$$

In some examples, for a single accepted proposal (m=1), the probability may be represented as follows:

$${a}_{1} = {a}_{0} [ \begin{matrix}{p}_{1} & {p}_{2} & … & {p}_{n} ] \cdot [ \begin{matrix}\frac{1}{{r}_{1}} & \frac{1}{{r}_{2}} & … & \frac{1}{{r}_{n}} ] = {a}_{0} {\sum }_{i = 1}^{n} {p}_{i} / {r}_{i}\end{matrix}\end{matrix} \qquad ( 13 )$$

In various examples, the joint probability of multibook instance (e.g., two to n accepted proposals) may include a complement of 0 to 1 accepted proposals, such as that illustrated in the following equation:

α₁+ . . . +αₙ=1−α₀−α₁ (14)

In various examples, one or more probabilities of a multibook instance (e.g., joint probability of multibook instance) may be included in the results page 400, such as in a first joint probability of multibook instance column 418 associated with a joint probability of multibook instance associated with the respective time slot 402 based on the pending meeting invitations. Additionally, the results page 400 may include a new meeting forecast multibook column 420 with multibook values associated with respective time slots. The multibook values associated with the new meeting forecast multibook column 420 may include the joint probability of multibook instance associated with a new meeting request, such as that described above. In some examples, the results page may include a net new meeting multibook column 422 including a net joint probability of multibook instance associated with the respective time slot based on the pending meeting invitations and the new meeting request.

In the illustrative example, the results page 400 includes results data associated with two different models, model A 424 and model B 426, though this is merely for illustrative purposes and a new meeting request may be applied to a greater or lesser number of models. The models, model A 424 and model B 426, represent prediction models with different parameters. The parameters may include different variables, different tolerances (e.g., more or less multibook risk tolerant, etc.), different thresholds, different preferences applied, and the like. As discussed above, the parameters of a particular prediction model may be determined by the scheduling platform and/or by an organization and/or representative associated therewith. In at least one example, the models represent risk tolerance models, in which a first model (e.g., model A 424) may have greater risk tolerance for a parameter than a second model (e.g., model B 426).

In some examples, each of model A 424 and model B 426 may include at least one column representative of a level of acceptable multibook risk. In the illustrative example, model A 424 and model B 426 each include three columns with different levels of acceptable risk. For example, model A 424 includes a first column Al with a least risk, set at zero (0), a second column A2 with a medium risk, set at one (1), and a third column A3 with a more risk tolerant value, set at three (3). For another example, the model B 426 includes a first column B1 with a least risk, set at zero (0), a second column B2 with a medium risk, set at one (1), and a third column B3 with a more risk tolerant value, set at one and a half (1.5). However, it is contemplated that each model may include a greater or lesser number of different risk tolerance settings.

In various examples, the different risk tolerance settings may include non-linear values. In such examples, the level of risk accepted with a higher risk tolerance, such as in association with column B3, and a level of risk accepted with the lower risk tolerance, such as in association with column B1 may have a non-linear relationship to one another. In various examples, the increased level of risk tolerance, may represent a preference to risk a multibook instance in favor of maximizing an acceptance of an invitation in a particular time slot 402.

In various examples, the scheduling platform evaluates the data associated with each time slot 402 and determines an optimal time to schedule a new meeting associated with the new meeting request. In the illustrative example, the scheduling platform selects the 10^{th} time slot 402 for scheduling the new meeting. In various examples, the scheduling platform may generate an invitation for the new meeting and may send the invitation to the contact associated with the new meeting request.

In various examples, the scheduling platform may receive a declining response to the new meeting invitation. In such examples, the scheduling platform may determine another time slot 402 for the new meeting, utilizing the techniques described above. In some examples, the scheduling platform may receive acceptance response to the new meeting invitation. In such examples, the scheduling platform may book the new meeting on the calendar of an associated representative. In some examples, prior to receiving either the declining response or the acceptance response (e.g., when the invitation is pending), the scheduling platform may schedule the meeting on a secondary calendar associated with the representative utilizing techniques such as those described in U.S. patent application Ser. No. 17/525,015, filed Nov. 12, 2021 and entitled “Intelligent Scheduling via a Secondary Calendar,” the entire contents of which are incorporated herein by reference for all purposes.

In various examples, the scheduling platform may receive an acceptance response associated with the new meeting invitation and another acceptance response associated with another pending meeting invitation corresponding to a same time slot 402. The scheduling platform may determine an instance of a multibook associated with the time slot 402. In some examples, the scheduling platform may provide a notification of the multibook instance to the associated representative. In such examples, the representative may coordinate an alternative time for at least one of the accepted invitations.

In some examples, the scheduling platform may be configured to proactively prevent the multibook instance. In such examples, the scheduling platform may identify a first of the two invitations associated with the particular time slot 402 and may identify one or more other pending meeting invitations associated with the particular time slot 402. The scheduling platform may update a time associated with the one or more other pending meeting invitations prior to acceptance thereof, thereby preventing the multibook instance. In some examples, the scheduling platform may be configured to send an updated meeting invitation associated with the other pending meeting invitation(s). In some examples, the scheduling platform may be configured to modify data associated with a previously sent pending meeting invitation, such as to modify the date and/or time associated with the pending meeting invitation without the need to send an updated invitation.

In various examples, the scheduling platform may be configured to intelligently coordinate a multibook instance, such as to maintain a meeting in the multibook time slot, and determine another time for the other meeting. In some examples, the scheduling platform may determine the meeting to maintain in the multibook time slot based on characteristics of the meeting, such as contact data, meeting data, or the like. For example, the scheduling platform may determine that a particular meeting associated with a multibook instance is a high value meeting or is associated with an important person in a particular organization (e.g., CEO, COO, etc.). The scheduling platform may determine to maintain the time slot associated with the high value meeting and may modify a time associated with one or more other meetings scheduled at the same time.

In some examples, the scheduling platform may determine to maintain a meeting in the multibook time slot based on contact data, such as if the contact is a high revenue customer, returning customer, frequent customer, or the like. In such examples, based on the contact data, the scheduling platform may prioritize a particular meeting and may reschedule other meeting(s) associated with the multibook timeslot.

Though particular equations associated with the scheduling optimization system are included herein, at least with respect to FIGS. 1 and 4, these are merely for illustrative purposes, and additional and/or alternate equations may be used. For example, standard deviation may be computed from a sum and sum of squares, and Pearson's correlation coefficient may likewise be computed in constant time per new datum from various sums. For another example, the scheduling platform may utilize Wald's sequential probability ratio test may be used to compute the probability p₁ that a series of data X=[x₁x₂ . . . xₙ] conforms to f₁(x). For example, Wald's formula may be used to test X against two hypothetical normal distributions with different means but the same standard deviation (e.g., two gauss curves with the same or similar dilation).

In various examples, the scheduling optimization system may be configured to determine probabilities associated with scheduling a new meeting across multiple calendars. In such examples, the scheduling optimization system may be configured to determine an optimal time for scheduling a new meeting for multiple people. For example, a new meeting request received from a contact (or individual) may include a request to meet with three other people (e.g., meeting attendees). The scheduling optimization system may utilize the prediction model to determine probabilities associated with each calendar of the three other people (e.g., simultaneous determination of probabilities). Based on the probabilities associated with each calendar, the scheduling optimization system may identify an optimal time for the meeting for all of the meeting attendees. In various examples, the optimal time may include a time slot associated with a highest average acceptance probability across the associated calendars. In some examples, the optimal time may include a time slot associated with a lowest joint probability of multibook instance across the associated calendars. In some examples, the optimal time may include a time slot associated with an optimized acceptance probability and joint probability of multibook instance, such as based on risk tolerances associated with the meeting attendees, an organization associated therewith, a model used, or the like.

FIG. 5 illustrates an example multi-dimensional prediction model 500 of a scheduling optimization system usable to determine an optimal time for scheduling meetings, in accordance with examples of the disclosure. As discussed above, the prediction model associated with a scheduling platform may include a multi-dimensional (e.g., spatial) model with each dimension 502 corresponding to a different variable 504. In the illustrative example, a first dimension 502(1) corresponds to a first variable 504(1), a second dimension 502(2) corresponds to a second variable 504(2), and an Nth dimension 502(K) corresponds to an Nth variable 504(K), where (K) represents a number of variables 504 associated with the prediction model 500.

In various examples, the number of variables 504 may be a predetermined number, as set by the scheduling platform. In some examples, the number of variables 504 may include a default number and/or type of variables 504 and/or additional variables 504 included in the prediction model 500, such as based on organizational or representative preferences, as described above. For example, the prediction model 500 may include a default set of variables 504 to apply. The scheduling platform may receive a request from a computing device associated with an organization (e.g. representative computing device 110, etc.) to associate a new variable with the prediction model 500. Responsive to the request, the prediction model 500 may plot one or more points 506 of historical data corresponding to the new variable and assign a weight to the variable based on a determined correlation between the variable and an acceptance probability. As illustrated the points 506 may represent accepted invitations and declined invitations. The points 506 associated with a particular variable 504 may represent a value of that variable associated with the historical data (e.g., previously accepted or declined invitations).

The prediction model 500 may be configured to automatically determine a weight associated with each variable 504 based on historical data. In some examples, the weight may be based on an average distance of the points from the center of mass. In various examples, the weight may represent a strength of the correlation between the variable 504 and an acceptance of a meeting invitation. In such examples, strong correlations between a variable, such as first variable 504(1) and an acceptance of the meeting invitation may be weighted higher than other variables.

In various examples, the prediction model may assign a first weight (e.g., 0.8, 1.5, etc.) to a first variable 504(1) based on a first correlation value, a second weight (e.g., 0.2, 0.3, etc.) to a second variable 504(2) based on a second correlation value, and a Kth weight to the Kth variable based on a Kth correlation value. In some examples, the correlation and/or value associated therewith may be determined based on a distribution of the points in the group of points 506 plotted with respect to the variable 504. For example, a first group of points 506(1) may include a first correlation value based on a first distribution (cluster) of the group of points 506(1), a second group of points 506(2) may include a second correlation value based on a second distribution of the group of points 506(2), and a third group of points 506(K) may include a kth correlation value based on a kth distribution of the group of points 506(K). In at least one example, the correlation value may be based on an average distance between each point in the group of points 506 and a center thereof.

In some examples, the prediction model 500 may be configured to identify one or more variables 504 in which the correlation value that is less than a threshold value (e.g., little to no correlation between the variable 504 and acceptance of a meeting invitation). In such examples, the prediction model may assign the variable(s) 504 with a correlation value less than the threshold value a weight of zero (0), effectively treating the variables 504 as noise. For example, the prediction model 500 may determine that the Kth distribution of the group of points 506(K) represents little to no correlation between the variable 504(K) and acceptance of a meeting invitation. The prediction model 500 may thus associate a weight of (0) to the Kth variable.

In various examples, the prediction model 500 may be configured to determine an optimal time associated with a new meeting based on the variables 504 and the weights associated with each variable 504. The scheduling platform may receive a request for a new meeting (e.g., new meeting request, such as new meeting request 130) and may determine characteristics associated with the request (e.g., contact data, meeting data, etc.). The prediction model 500 may associate the new meeting with one or more available times associated with one or more representatives. The available times may represent times that are not associated with a confirmed meeting or are not otherwise blocked on a calendar (e.g., a representative blocks a day as being unavailable, such as for vacation) associated with the one or more representatives.

In various examples, the prediction model 500 plots a point 508 associated with the new meeting based on the corresponding variables and at a time of the one or more available times. The prediction model 500 determines a first distance from the point to each of the accept invitation points (DA) and a second distance from the point to the decline invitation points (DNA). In some examples, the prediction model 500 may determine a first average (e.g., mean, median, mode, etc.) distance associated with the accept invitation points and a second average distance associated with the decline invitation points. In various examples, the prediction model may determine the acceptance probability based on the first and second average distances.

In at least one example, the acceptance probability may be determined based on weighted first and second average distances, utilizing the calculated variable weights, as described above. In such an example, the prediction model 500 may apply the determined weights associated with each variable 504 to the average distances to determine an acceptance probability corresponding to the new meeting being scheduled at a particular time (e.g., time associated with point 508).

Though illustrated in FIG. 5 as a multi-dimensional (spatial) model, other probability prediction models are contemplated herein. For example, the acceptance probability and/or joint probability of multibook instance may be determined utilizing a machine learning model, a statistical model, a heuristic model, and/or a combination of the foregoing (e.g., a hybrid model combining the multi-dimensional model and one or more other models).

In at least one example, the prediction model 500 may be configured to determine an acceptance probability associated with a plurality of time slots (e.g., available times on the calendar), such as those illustrated in FIG. 3 and/or FIG. 4.

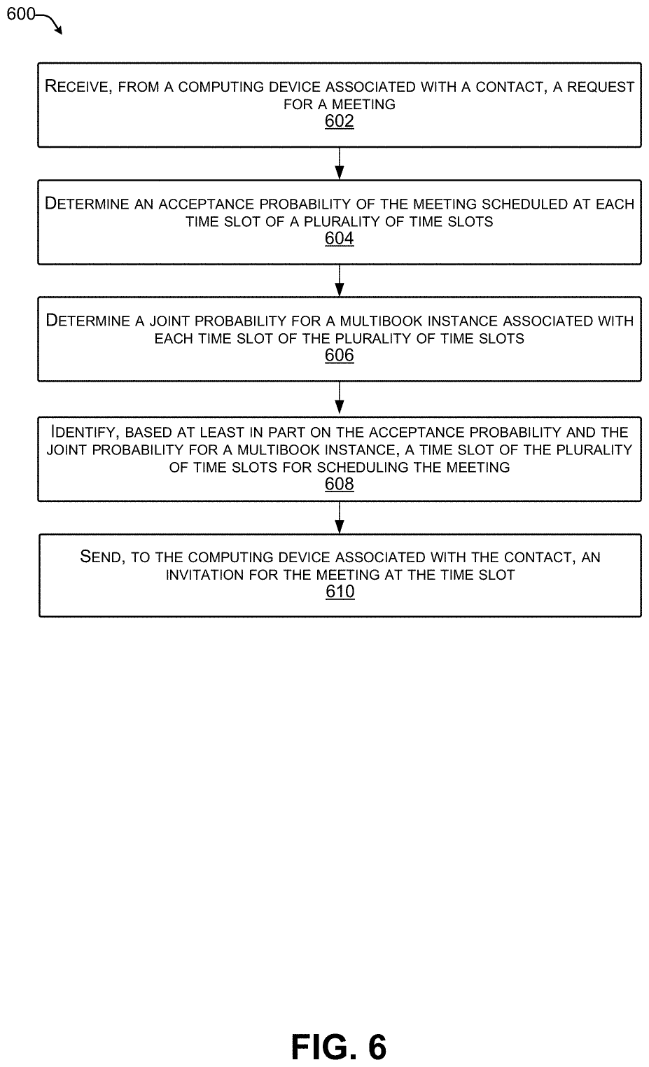

FIGS. 6-8 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

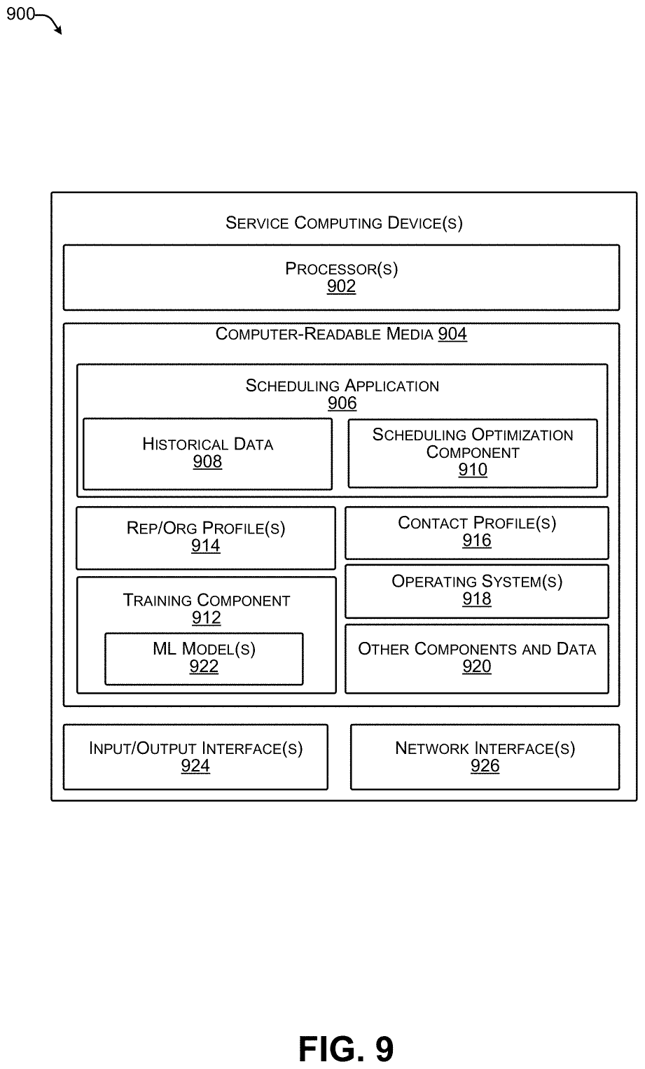

FIG. 6 illustrates an example process for identifying an optimal time for scheduling a meeting, in accordance with examples of the disclosure. As discussed herein, a scheduling platform may be configured to automatically determine a time for a meeting and/or schedule a meeting between a representative and a contact. In some instances, some or all of process 600 may be performed by one or more components in the system 100 (e.g., scheduling platform 104, representative computing device 110, and/or contact computing device 112) and/or by one or more components of the service computing device 900 of FIG. 9.

At operation 602, the process 600 includes receiving, from a computing device associated with a contact, a request for a meeting. The request may include meeting data, contact data, representative data, and the like. In some examples, the request may include a generic inquiry about a product of an organization, such as a demonstration of capabilities. In some examples, the request may include a specific request to meet with one or more particular representatives associated with an organization. In various examples, the request may be received via a website associated with the organization, a scheduling application, an electronic mail communication, or the like.

At operation 604, the process 600 includes determining an acceptance probability of the meeting scheduled at each time slot of a plurality of time slots. The time slots may include times (e.g., period of time) that are available on a calendar associated with one or more representatives. In some examples, the calendar may include a calendar associated with a single representative. In some examples, the calendar may include a calendar associated with two or more representatives of an organization, with time slots associated with particular representatives. For example, the calendar may include a calendar associated with team members of a team of the organization.

At operation 606, the process 600 includes determining a joint probability of multibook instance (e.g., probability of a multibook instance) associated with each time slot of the plurality of time slots. The joint probability of multibook instance may be determined utilizing the techniques described above.

At operation 608, the process 600 includes identifying, based at least in part on the acceptance probability and the joint probability of multibook instance, a time slot of the plurality of time slots for scheduling the meeting. In some examples, the time slot may be identified based on one or more thresholds associated with the acceptance probability and the joint probability of multibook instance. In some examples, the thresholds may be determined based on default settings, organizational preference, representative preferences, or the like.

At operation 610, the process 600 includes sending, to the computing device associated with the contact, an invitation for the meeting at the time slot. In some examples, the invitation may be delivered via a scheduling application associated with the scheduling platform, such as scheduling application 102. In such examples, the invitation may be delivered via direct message, notification (e.g., pop up notification, etc.), or other means of delivery via the scheduling application. In some examples, the invitation may be delivered via electronic mail, text message, automated telephone message, or the like.

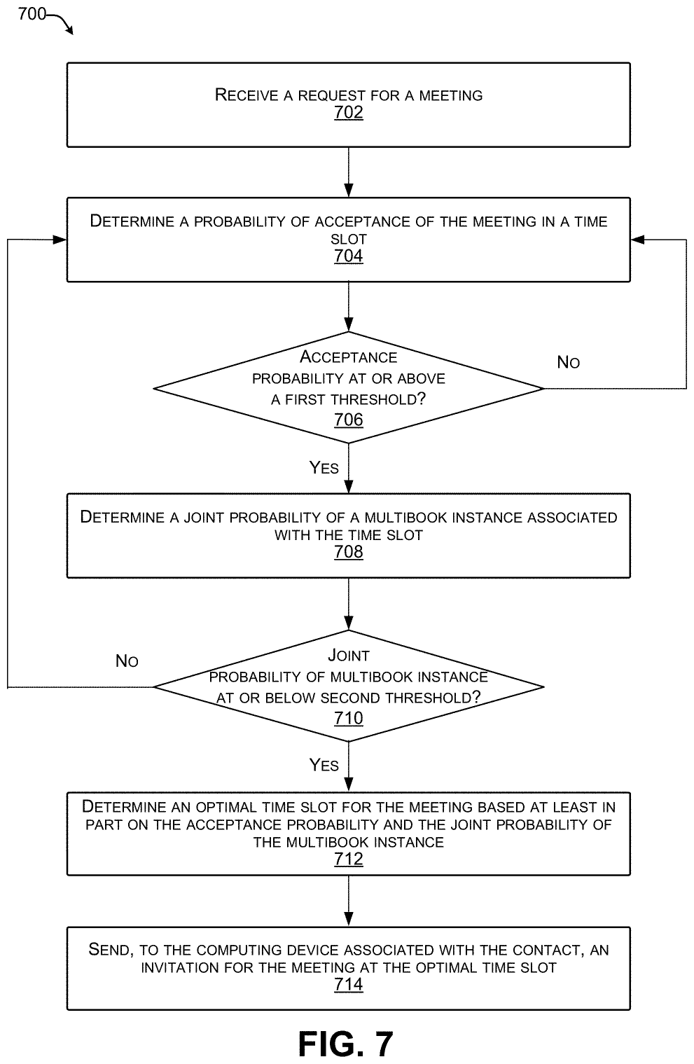

FIG. 7 illustrates an example process for identifying an optimal time for scheduling a meeting based on an acceptance probability and a joint probability of multibook instance, in accordance with examples of the disclosure. In some instances, some or all of process 700 may be performed by one or more components in the system 100 (e.g., scheduling platform 104, representative computing device 110, and/or contact computing device 112) and/or by one or more components of the service computing device 900 of FIG. 9.

At operation 702, the process 700 includes receiving a request for a meeting. In some examples, the request may be received from a computing device associated with a contact. In some examples, the request may be received from a computing device of a representative and/or another representative authorized to schedule meetings on behalf of the representative (e.g., other representative configured to act as a proxy for the representative). The request may include meeting data, contact data, representative data, and the like. In some examples, the request may include a generic inquiry about a product of an organization, such as a demonstration of capabilities. In some examples, the request may include a specific request to meet with one or more particular representatives associated with an organization. In various examples, the request may be received via a website associated with the organization, a scheduling application, an electronic mail communication, or the like.

At operation 704, the process 700 includes determining an acceptance probability of the meeting scheduled in a time slot (e.g., a first time slot). The time slot may include a time (e.g., period of time) that is available on a calendar associated with one or more representatives. In some examples, the calendar may include a calendar associated with a single representative. In some examples, the calendar may include a calendar associated with two or more representatives of an organization, with the time slot being associated with a particular representative.

As discussed above, the acceptance probability of the meeting in the time slot may be determined utilizing a prediction model (e.g., machine learning model, spatial model, etc.) including a plurality of dimensions that represent a plurality of variables associated with the meeting. In various examples, the acceptance probability may be determined based on historical data, such as data associated with previously accepted and declined invitations.

In various examples, the acceptance probability may be additional or alternatively determined based on predicted future meetings. In such examples, the scheduling platform may be configured to hypothesize future meetings, such as to simulate time slot contention associated with one or more organizations. In various examples, the future meetings may be simulated based on heuristics associated with a particular organization and/or across organizations. The future meetings may be associated with a time of the year in which the meetings are hypothesized and/or other meeting data relevant to predicting a number or frequency of meetings. For example, the scheduling platform may predict future meetings at the beginning of a fiscal year, when budgets are renewed.

At operation 706, the process 700 includes determining whether an acceptance probability associated with the meeting in the time slot is above a threshold acceptance probability (e.g., a first threshold). The threshold acceptance probability may include a minimum acceptance probability of a meeting as set by the scheduling platform, such as in a default setting. In some examples, the threshold acceptance probability may be determined based on one or more organizational or representative preferences. In some examples, the threshold acceptance probability may be determined based on a multibook risk tolerance associated with a representative and/or an organization thereof.

Based on a determination that the acceptance probability is below the threshold acceptance probability (“No” at operation 706), the process 700 returns to operation 704 and determines a second acceptance probability of the meeting in a second time slot. In various examples, the scheduling platform may continue to associate the meeting with different time slots until it determines that an acceptance probability associated with a particular time slot is at or above the threshold acceptance probability.

Based on a determination that the acceptance probability is at or above the threshold acceptance probability (“Yes” at operation 706), the process 700, at operation 708, includes determining a joint probability of multibook instance associated with the time slot. As discussed above, the scheduling platform may determine the joint probability of multibook instance associated with the time slot utilizing one or more prediction models generated based on historical data. In some examples, the scheduling platform may determine the joint probability of multibook instance utilizing heuristics, statistical models, machine learning techniques, or the like.

At operation 710, the process 700 includes determining whether a joint probability of multibook instance is at or below a threshold joint probability of multibook instance (e.g., second threshold). The threshold joint probability of multibook instance may include a maximum probability that two or more meeting invitations will be accepted in a given time slot (e.g., the first time slot), as set by the scheduling platform, such as in a default setting. In some examples, the threshold joint probability of multibook instance may be determined based on one or more organizational or representative preferences. In some examples, the threshold joint probability of multibook instance may be determined based on a desired invitation acceptance rate associated with a representative and/or an organization thereof

Based on a determination that the joint probability of multibook instance is above the threshold joint probability of multibook instance (“No” at operation 710), the process 700 returns to operation 704 and determines a second acceptance probability of the meeting in a second time slot. In various examples, the scheduling platform may continue to associate the meeting with different time slots until it determines that an acceptance probability associated with a particular time slot is at or above the threshold acceptance probability and a joint probability of multibook instance associated with the particular time slot is at or below a multibook threshold.

Based on a determination that the joint probability of multibook instance is at or below the threshold joint probability of multibook instance (“Yes” at operation 710), the process 700, at operation 712, includes determining an optimal time slot for the meeting based at least in part on the acceptance probability and the joint probability of multibook instance. In various examples, the optimal time slot includes a time associated with the acceptance probability and the joint probability of multibook instance satisfying respective thresholds. As discussed above, the respective thresholds may be determined based on a risk tolerance determined by the scheduling platform. In some examples, the risk tolerance may include a default risk tolerance, as set by the scheduling platform. In some examples, the risk tolerance may be determined based on input from a user, such as based on one or more preferences associated with the user, an organization, or the like.

At operation 714, the process includes sending, to the computing device associated with the contact, an invitation for the meeting at the optimal time slot. In some examples, the invitation may be sent via a scheduling application associated with the scheduling platform, such as scheduling application 102. In such examples, the invitation may be sent via direct message, notification (e.g., pop up notification, etc.), or other means of delivery via the scheduling application. In some examples, the invitation may be sent via electronic mail, text message, automated telephone message, or the like.

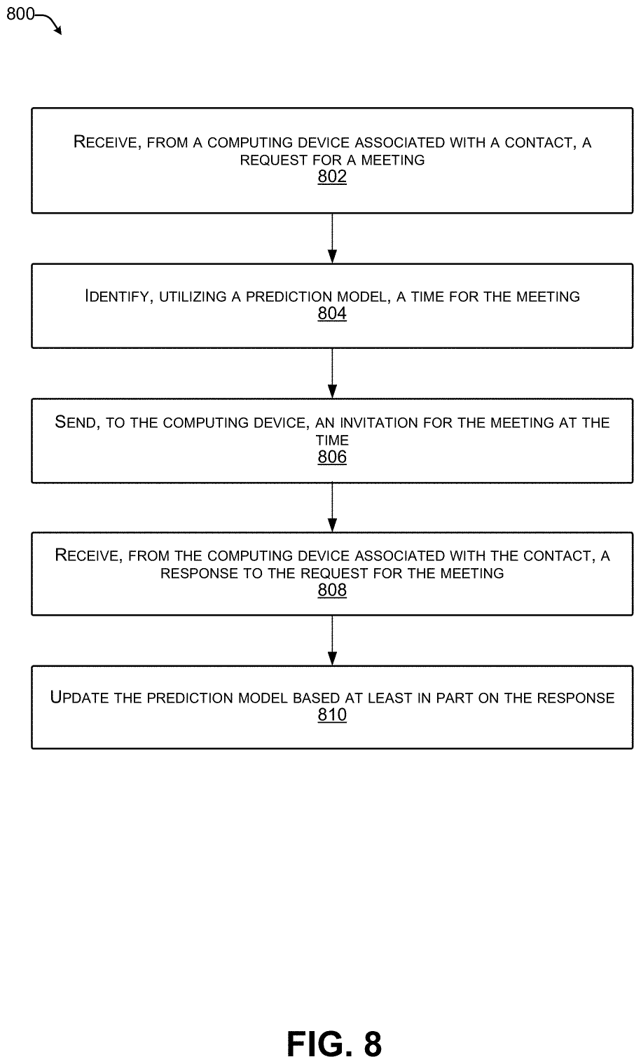

FIG. 8 illustrates an example process for updating a machine learning model for determining an optimal time for a meeting, in accordance with examples of the disclosure. In some instances, some or all of process 800 may be performed by one or more components in the system 100 (e.g., scheduling platform 104, representative computing device 110, and/or contact computing device 112) and/or by one or more components of the service computing device 900 of FIG. 9.

At operation 802, the process 800 includes receiving, from a computing device associated with a contact, a request for a meeting. The request may include meeting data, contact data, representative data, and the like. In some examples, the request may include a generic inquiry about a product of an organization, such as a demonstration of capabilities. In some examples, the request may include a specific request to meet with one or more particular representatives associated with an organization. In various examples, the request may be received via a website associated with the organization, a scheduling application, an electronic mail communication, or the like.

At operation 804, the process 800 includes identifying, utilizing a prediction model, a time for the meeting. In various examples, the prediction model may include a machine learning model including a plurality of dimensions associated with a plurality of variables considered in determining an acceptance probability of a particular meeting invitation. In various examples, the prediction model may determine the time for the meeting based on an acceptance probability and/or a j oint probability of multibook instance associated with the time, as discussed above.

At operation 806, the process 800 includes sending, to the first computing device, an invitation for the meeting at the time. In some examples, the invitation may be sent via a scheduling application associated with the scheduling platform, such as scheduling application 102. In such examples, the invitation may be sent via direct message, notification (e.g., pop up notification, etc.), or other means of delivery via the scheduling application. In some examples, the invitation may be sent via electronic mail, text message, automated telephone message, or the like.

At operation 808, the process 800 includes receiving, from the computing device associated with the contact, a response to the request for the meeting. The response may include an accepted or a declined invitation. In various examples, the scheduling platform may store data associated with the response in a datastore. In such examples, the data may include contact data, representative data, meeting data, previously calculated acceptance and/or probabilities, and/or other data relevant to the meeting.

In some examples, responsive to receiving a declined invitation, the scheduling platform may determine another time for the meeting, such as utilizing the prediction model. In such examples, the scheduling platform may update and resend another invitation for the meeting at the other time.

At operation 810, the process 800 includes updating the model based at least in part on the response. In various examples, an update to the model may include incorporating the response into the prediction model as an additional historical data point, such as to improve accuracy of prediction of the acceptance probability and/or the j oint probability of multibook instance. In some examples, the prediction model may include a maximum number of data points associated with a maximum number of previously accepted and/or declined invitations. In some examples, based on a determination that a number of data points and/or previously accepted and/or declined invitations is at a maximum number, the update to the prediction model may include and incorporating the new invitation into the prediction model and removing at least one data point associated with an historical invitation from the prediction model. In some examples, the scheduling platform may determine an oldest historical invitation (e.g., previously accepted or declined invitation) with a timestamp (e.g., delivery date, acceptance or declined date, etc.) that is older than other historical invitations.

FIG. 9 is a block diagram illustrating an example service computing device 900 usable to implement example techniques described herein. The service computing device 900 may include one or more servers or other types of computing devices that may be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

The service computing device 900 may be any suitable type of computing device, e.g., mobile, semi-mobile, semi-stationary, or stationary. The service computing device 900 may belong to a variety of categories or classes of devices such as traditional server-type devices, desktop computer-type devices, mobile devices, special purpose-type devices, embedded-type devices, and/or wearable-type devices. Thus, service computing device 900 may include a diverse variety of device types and are not limited to a particular type of device. For example, the service-computing device 900 may represent, but are not limited to, desktop computers, server computers or blade servers such as web-servers, map-reduce servers, or other computation engines or network-attached storage units, personal computers, mobile computers, laptop computers, tablet computers, telecommunication devices, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device capable of sending communications and performing the functions according to the techniques described herein.

In the illustrated example, the service computing device 900 includes at least one processor 902. The processor 902 may itself comprise one or more processors or processing cores. For example, the processor 902 may be implemented as one or more microprocessors, microcomputers, microcontrollers, digital signal processors, central processing units, state machines, logic circuitries, and/or any devices that manipulate signals based on operational instructions. In some cases, the processor 902 may be one or more hardware processors and/or logic circuits of any suitable type specifically programmed or configured to execute the algorithms and processes described herein. The processor 902 may be configured to fetch and execute computer-readable processor-executable instructions stored in a memory 904 of the service computing device 900 (illustrated as computer-readable media 904).

Depending on the configuration of the service computing device 900, the memory 904 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 904 may include, but is not limited to, RAM, ROM, EEPROM, flash memory, solid-state storage, magnetic disk storage, optical storage, and/or other computer-readable media technology. Further, in some cases, the service computing device 900 may access external storage, such as RAID storage systems, storage arrays, network attached storage, storage area networks, cloud storage, or any other medium that may be used to store information and that may be accessed by the processor 902 directly or through another computing device or network, such as network 116. Accordingly, the memory 904 may be computer storage media able to store instructions, modules or components that may be executed by the processor 902. Further, when mentioned, non-transitory computer-readable media exclude media such as energy, carrier signals, electromagnetic waves, and signals per se.

The memory 904 may be used to store and maintain any number of functional components that are executable by the processor 902. In some examples, these functional components comprise instructions or programs that are executable by the processor 902 and that, when executed, implement operational logic for performing the actions and services attributed above to the service computing device 900. Functional components of the service computing device 900 stored in the memory 904 may include a scheduling application 906, such as scheduling application 102, historical data 908, such as historical data 126, a scheduling optimization component 910, such as scheduling optimization component 128, and a training component 912, such as training component 132. Additionally, functional components of the service computing device 900 stored on the memory 904 may include one or more organization and/or representative profiles 914, such as those stored in profile(s) 122, contact profiles 916, such as contact profiles 124, one or more operating system(s) 918, and/or other components and data 920.

As discussed above, the service computing device 900 may include a scheduling application 906 for scheduling one or more meetings with representatives. In some examples, the service computing device 900 may manage a scheduling client application on a representative computing device, such as representative computing device 110, and/or on a contact computing device, such as contact computing device 112. In some examples, the service computing device 900 may include an application programming interface between the scheduling application 906 and the scheduling client application(s).

In various examples, the historical data 908 may include data associated with a single organization and/or multiple organizations. In various examples, the historical data 908 may include meeting data associated with the previously scheduled meetings. The meeting data may include known information about the previously scheduled meetings, such as representative data (e.g., name, contact, preferences, productivity level, revenue, conversion rate, etc.), contact data, scheduling data (e.g., time of day, day of week, etc.), meeting data (e.g., meeting type, meeting value, revenue collected as a result of the meeting, etc.), invitation data (e.g., invitations delivered, updates requested from contact, invitations accepted, invitations ignored, invitations declined, etc.) and the like.

In various examples, the historical data 908 may additionally include data associated with one or more predicted future meetings. In some examples, the scheduling platform (e.g., via the scheduling application 906) may be configured to hypothesize future meetings, such as to simulate time slot contention in association with one or more organizations. The predicted future meetings may be simulated based on heuristics associated with the organization(s). The future meetings may be associated with a time of the year in which the meetings are hypothesized and/or other meeting data relevant to predicting a number or frequency of meetings associated with the organization(s).

In various examples, the scheduling optimization component 910 of the service computing device 900 may determine an optimal time for scheduling a meeting associated with a new meeting request. As discussed above, the optimal time may be determined based on an acceptance probability and/or a joint probability of multibook instance associated with the particular time slot corresponding to the optimal time. In various examples, the scheduling optimization component 910 may determine the optimal time utilizing a prediction model (e.g., machine learning model, spatial model, etc.). In some examples, the scheduling optimization component 910 may determine the acceptance probability, the joint probability of multibook instance, and/or the optimal time utilizing other statistical models and/or machine learning techniques.

As discussed above, the service computing device 900 may include a training component 912. In various examples, the training component 912 may access historical data, contact data, organizational data, and/or representative data and may process the data to train one or more machine learning model(s) 922, such as machine learning model(s) 134 of FIG. 1. In some examples, the machine learning model(s) 922 may be trained to determine one or more of an acceptance probability, a joint probability of multibook instance, a confidence associated with the acceptance probability and/or the joint probability of multibook instance, organizational similarity (e.g., for identifying historical data to utilize in a model associated with a particular organization, etc.), and/or other functions described herein in which machine learning techniques may be used. In some examples, the training component 912 may utilize machine learning techniques to train the machine learning model(s) 922. Additionally or alternatively, the machine learning model(s) 922 may utilize one or more statistical models for processing data and determining an outcome.

Additional functional components of the service computing device 900 may include the operating system 918, for controlling and managing various functions of the service computing device 900. The memory 904 may also store other components and data 920, which may include programs, drivers, etc., and the data used or generated by the functional components, to enable meeting scheduling and meeting presentation to the representative. Further, the service computing device 900 may include many other logical, programmatic and physical components, of which those described are merely examples that are related to the discussion herein. In addition, the memory 904 may also store data, data structures and the like, that are used by the functional components.

In various examples, the service computing device 900 may include one or more input/output (I/O) interfaces 924. The I/O interface(s) 924, may include speakers, a microphone, a camera, and various user controls (e.g., buttons, a joystick, a keyboard, a keypad, etc.), a haptic output device, and so forth. Additionally, the service computing device 900 may include one or more network interfaces 926. The network interface(s) 926 may include one or more interfaces and hardware components for enabling communication with various other devices over the network or directly. For example, network interface(s) 926 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

### EXAMPLE CLAUSES

A: A method comprising: receiving, from a contact computing device associated with a contact, a request for a meeting instance between the contact and a representative of an organization; determining an acceptance probability for the meeting instance being scheduled at each time slot of a plurality of time slots on a calendar of the representative; determining a probability for a multibook instance associated with at least one time slot of the plurality of time slots; identifying, based at least in part on acceptance probabilities and probabilities for the multibook instance, a time slot of the meeting instance; and sending, to the contact computing device, an invitation for the meeting instance associated with the time slot.

B: The method of paragraph A, further comprising identifying available time slots on a calendar of the representative; and identifying the available time slots as the plurality of time slots on the calendar of the representative.

C: The method of paragraph B, further comprising: determining a first time associated with the request for the meeting instance; and determining a minimum time period and a maximum time period for scheduling the meeting instance, wherein identifying available time slots on the calendar of the representative comprises identifying available time slots between the minimum time period and the maximum time period.

D: The method of any one of paragraphs A-C, wherein at least one of the acceptance probability or the probability for the multibook instance is determined utilizing one or more prediction models, the method further comprising: receiving, from the contact computing device, an indication that the meeting instance associated with the time slot was accepted or declined; and training the one or more prediction models based on the indication.

E: The method of any one of paragraphs A-D, further comprising: determining a first weight associated with the probabilities of acceptance and a second weight associated with the probabilities of the multibook instance; wherein identifying the time slot of the meeting instance is based at least in part on at least one of the first weight or the second weight.

F: The method of any one of paragraphs A-E, further comprising: determining a first acceptance probability associated with a first time slot of the plurality of time slots; and determining that the first acceptance probability is equal to or greater than a threshold probability; wherein determining the probability for the multibook instance associated with the at least one time slot of the plurality of time slots comprises determining a first probability for the multibook instance associated with the first time slot based at least in part on a determination that the first acceptance probability is equal to or greater than the threshold probability.

G: The method of any one of paragraphs A-F, further comprising: determining time slots to associate with meeting instances for the representative based on requests for the meeting instances, wherein the time slots are determined: based on at least one of a plurality of acceptance probabilities or a plurality of probabilities for the multibook instance, and to maximize a density of accepted meetings on a calendar of the representative.

H: A system comprising: one or more processors; one or more non-transitory computer-readable media comprising instructions that, when executed by the one or more processors, cause the system to perform operations comprising: receiving a request for a meeting instance between a contact and a representative of an organization; determining a first acceptance probability associated with a first time slot on a calendar of a representative and a second acceptance probability associated with a second time slot on the calendar of the representative; identifying, based at least in part on the first acceptance probability and the second acceptance probability, a time slot for the meeting instance, wherein the time slot comprises the first time slot or the second time slot; and sending, to a contact computing device associated with the contact, an invitation for the meeting instance associated with the time slot.

I: The system of paragraph H, the operations further comprising: determining a first probability for a multibook instance associated with the first time slot and a second probability for the multibook instance associated with the second time slot, wherein the time slot of the meeting instance is further identified based at least in part on the first probability for the multibook instance and the second probability for the multibook instance.

J: The system of paragraph I, the operations further comprising: determining a first weight to apply to acceptance probabilities and a second weight to apply to probabilities for the multibook instance; and determining a first weighted acceptance probability and a second weighted acceptance probability based on the first weight and a first weighted probability for the multibook instance and a second weighted probability for the multibook instance based on the second weight; wherein identifying the time slot for the meeting instance is further based at least in part on the first weighted acceptance probability, the first weighted probability for the multibook instance, the second weighted acceptance probability, and the second weighted probability for the multibook instance.

K: The system of any one of paragraphs H-J, the operations further comprising: determining that the first acceptance probability is equal to or greater than a threshold probability; and determining a first probability for a multibook instance associated with the first time slot based at least in part on a determination that the first acceptance probability is equal to or greater than the threshold probability, wherein the time slot is further identified based at least in part on the first probability for the multibook instance.

L: The system of any one of paragraphs H-K, the operations further comprising: determining that the first acceptance probability is greater than the second acceptance probability; and identifying the first time slot as the time slot for the meeting instance based at least in part on a determination that the first acceptance probability is greater than the second acceptance probability.

M: The system of any one of paragraphs H-L, the operations further comprising: identifying available time slots on a calendar of the representative; and identifying the first time slot and the second time slot from the available time slots based at least in part on at least one of a minimum time period or a maximum time period from a time associated with receiving the request.

N: The system of any one of paragraphs H-M, wherein the first acceptance probability and the second acceptance probability are determined utilizing one or more prediction models, the operations further comprising: receiving, from the contact computing device, an indication that the meeting instance associated with the time slot was accepted or declined; and training the one or more prediction models based on the indication.

O: The system of any one of paragraphs H-N, wherein the request is received from at least one of: a contact computing device associated with the contact; or a representative computing device associated with the representative or a proxy of the representative.

P: One or more non-transitory computer readable media storing instructions that, when executed by one or more processors, cause the one or more processors to perform operations comprising: receiving a request for a meeting instance between a contact and a representative of an organization; determining a first acceptance probability associated with a first time slot on a calendar of a representative and a second acceptance probability associated with a second time slot on the calendar of the representative; identifying, based at least in part on the first acceptance probability and the second acceptance probability, a time slot for the meeting instance, wherein the time slot comprises the first time slot or the second time slot; and sending, to a contact computing device associated with the contact, an invitation for the meeting instance associated with the time slot.

Q: The one or more non-transitory computer readable media of paragraph P, the operations further comprising: determining a first probability for a multibook instance associated with the first time slot and a second probability for the multibook instance associated with the second time slot, wherein the time slot of the meeting instance is further identified based at least in part on the first probability for the multibook instance and the second probability for the multibook instance.

R: The one or more non-transitory computer readable media of either paragraph P or paragraph Q, the operations further comprising: determining a first probability for a multibook instance associated with the first time slot and a second probability for the multibook instance associated with the second time slot; determining a first weight to apply to acceptance probabilities and a second weight to apply to probabilities for the multibook instance; and determining a first weighted acceptance probability and a second weighted acceptance probability based on the first weight and a first weighted probability for the multibook instance and a second weighted probability for the multibook instance based on the second weight; wherein identifying the time slot for the meeting instance is further based at least in part on the first weighted acceptance probability, the first weighted probability for the multibook instance, the second weighted acceptance probability, and the second weighted probability for the multibook instance.

S: The one or more non-transitory computer readable media of any one of paragraphs P-R, the operations further comprising: determining that the first acceptance probability is greater than the second acceptance probability; and identifying the first time slot as the time slot for the meeting instance based at least in part on a determination that the first acceptance probability is greater than the second acceptance probability.

T: The one or more non-transitory computer readable media of any one of paragraphs P-S, the operations further comprising: determining a first time associated with the request for the meeting instance; and determining a minimum time period and a maximum time period for scheduling the meeting instance, wherein the first time slot and the second time slot comprise time slots that are available on the calendar of the representative between the minimum time period and the maximum time period.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims. Furthermore, while techniques described herein are directed to techniques associated with scheduling services, similar techniques can be applicable for any type of services and should not be construed as being limited to only scheduling services.

What is claimed is:

1. A method comprising:
receiving, from a contact computing device associated with a contact, a request for a meeting instance between the contact and a representative of an organization;
determining an acceptance probability for the meeting instance being scheduled at each time slot of a plurality of time slots on a calendar of the representative;
determining a probability for a multibook instance associated with at least one time slot of the plurality of time slots;
identifying, based at least in part on acceptance probabilities and probabilities for the multibook instance, a time slot of the meeting instance; and
sending, to the contact computing device, an invitation for the meeting instance associated with the time slot.

2. The method of claim 1, further comprising:
identifying available time slots on a calendar of the representative; and
identifying the available time slots as the plurality of time slots on the calendar of the representative.

3. The method of claim 2, further comprising:
determining a first time associated with the request for the meeting instance; and
determining a minimum time period and a maximum time period for scheduling the meeting instance,
wherein identifying available time slots on the calendar of the representative comprises identifying available time slots between the minimum time period and the maximum time period.

4. The method of claim 1, wherein at least one of the acceptance probability or the probability for the multibook instance is determined utilizing one or more prediction models, the method further comprising:
receiving, from the contact computing device, an indication that the meeting instance associated with the time slot was accepted or declined; and
training the one or more prediction models based on the indication.

5. The method of claim 1, further comprising:
determining a first weight associated with the probabilities of acceptance and a second weight associated with the probabilities of the multibook instance;
wherein identifying the time slot of the meeting instance is based at least in part on at least one of the first weight or the second weight.

6. The method of claim 1, further comprising:
determining a first acceptance probability associated with a first time slot of the plurality of time slots; and
determining that the first acceptance probability is equal to or greater than a threshold probability;
wherein determining the probability for the multibook instance associated with the at least one time slot of the plurality of time slots comprises determining a first probability for the multibook instance associated with the first time slot based at least in part on a determination that the first acceptance probability is equal to or greater than the threshold probability.

7. The method of claim 1, further comprising:
determining time slots to associate with meeting instances for the representative based on requests for the meeting instances, wherein the time slots are determined:
based on at least one of a plurality of acceptance probabilities or a plurality of probabilities for the multibook instance, and
to maximize a density of accepted meetings on a calendar of the representative.

8. A system comprising:
one or more processors;
one or more non-transitory computer-readable media comprising instructions that, when executed by the one or more processors, cause the system to perform operations comprising:
receiving a request for a meeting instance between a contact and a representative of an organization;
determining a first acceptance probability associated with a first time slot on a calendar of a representative and a second acceptance probability associated with a second time slot on the calendar of the representative;
identifying, based at least in part on the first acceptance probability and the second acceptance probability, a time slot for the meeting instance, wherein the time slot comprises the first time slot or the second time slot; and
sending, to a contact computing device associated with the contact, an invitation for the meeting instance associated with the time slot.

9. The system of claim 8, the operations further comprising:
determining a first probability for a multibook instance associated with the first time slot and a second probability for the multibook instance associated with the second time slot,
wherein the time slot of the meeting instance is further identified based at least in part on the first probability for the multibook instance and the second probability for the multibook instance.

10. The system of claim 9, the operations further comprising:
determining a first weight to apply to acceptance probabilities and a second weight to apply to probabilities for the multibook instance; and
determining a first weighted acceptance probability and a second weighted acceptance probability based on the first weight and a first weighted probability for the multibook instance and a second weighted probability for the multibook instance based on the second weight;
wherein identifying the time slot for the meeting instance is further based at least in part on the first weighted acceptance probability, the first weighted probability for the multibook instance, the second weighted acceptance probability, and the second weighted probability for the multibook instance.

11. The system of claim 8, the operations further comprising:
determining that the first acceptance probability is equal to or greater than a threshold probability; and
determining a first probability for a multibook instance associated with the first time slot based at least in part on a determination that the first acceptance probability is equal to or greater than the threshold probability,
wherein the time slot is further identified based at least in part on the first probability for the multibook instance.

12. The system of claim 8, the operations further comprising:
determining that the first acceptance probability is greater than the second acceptance probability; and
identifying the first time slot as the time slot for the meeting instance based at least in part on a determination that the first acceptance probability is greater than the second acceptance probability.

13. The system of claim 8, the operations further comprising:
identifying available time slots on a calendar of the representative; and
identifying the first time slot and the second time slot from the available time slots based at least in part on at least one of a minimum time period or a maximum time period from a time associated with receiving the request.

14. The system of claim 8, wherein the first acceptance probability and the second acceptance probability are determined utilizing one or more prediction models, the operations further comprising:
receiving, from the contact computing device, an indication that the meeting instance associated with the time slot was accepted or declined; and
training the one or more prediction models based on the indication.

15. The system of claim 8, wherein the request is received from at least one of:
a contact computing device associated with the contact; or
a representative computing device associated with the representative or a proxy of the representative.

16. One or more non-transitory computer readable media storing instructions that, when executed by one or more processors, cause the one or more processors to perform operations comprising:
receiving a request for a meeting instance between a contact and a representative of an organization;
determining a first acceptance probability associated with a first time slot on a calendar of a representative and a second acceptance probability associated with a second time slot on the calendar of the representative;
identifying, based at least in part on the first acceptance probability and the second acceptance probability, a time slot for the meeting instance, wherein the time slot comprises the first time slot or the second time slot; and
sending, to a contact computing device associated with the contact, an invitation for the meeting instance associated with the time slot.

17. The one or more non-transitory computer readable media of claim 16, the operations further comprising:
determining a first probability for a multibook instance associated with the first time slot and a second probability for the multibook instance associated with the second time slot,
wherein the time slot of the meeting instance is further identified based at least in part on the first probability for the multibook instance and the second probability for the multibook instance.

18. The one or more non-transitory computer readable media of claim 16, the operations further comprising:
determining a first probability for a multibook instance associated with the first time slot and a second probability for the multibook instance associated with the second time slot;
determining a first weight to apply to acceptance probabilities and a second weight to apply to probabilities for the multibook instance; and
determining a first weighted acceptance probability and a second weighted acceptance probability based on the first weight and a first weighted probability for the multibook instance and a second weighted probability for the multibook instance based on the second weight;
wherein identifying the time slot for the meeting instance is further based at least in part on the first weighted acceptance probability, the first weighted probability for the multibook instance, the second weighted acceptance probability, and the second weighted probability for the multibook instance.

19. The one or more non-transitory computer readable media of claim 16, the operations further comprising:
determining that the first acceptance probability is greater than the second acceptance probability; and
identifying the first time slot as the time slot for the meeting instance based at least in part on a determination that the first acceptance probability is greater than the second acceptance probability.

20. The one or more non-transitory computer readable media of claim 16, the operations further comprising:
determining a first time associated with the request for the meeting instance; and
determining a minimum time period and a maximum time period for scheduling the meeting instance,
wherein the first time slot and the second time slot comprise time slots that are available on the calendar of the representative between the minimum time period and the maximum time period.
